(19) United States
(12) Patent Application Publication
(10) Pub. No.: US 2016/0342398 A1
(43) Pub. Date: Nov. 24, 2016

(54) Dynamic Semiotic Systemic Knowledge Compiler System and Methods

(71) Applicant: Alan A. Yelsey, Excelsior, MN (US)

(72) Inventor: Alan A. Yelsey, Excelsior, MN (US)

(21) Appl. No.: 15/160,913

(22) Filed: May 20, 2016

Related U.S. Application Data
(60) Provisional application No. 62/165,563, filed on May 22, 2015.

(51) Int. Cl. G06F 9/45

(52) U.S. Cl. CPC G06F 8/42

(57) ABSTRACT

Embodiments of the claimed invention rely on the semiotic accumulation and compilation of common language and data into a multisensory cybersemiotic medium and standardized dynamic semiotic language capable of signifying complex meaning associated with proof, proof processes, valuing and value exchanges, and all of the contextual systemic variables that enter into a whole and dynamic understanding of any given topic or set of topics.

### CROSS-REFERENCE TO RELATED APPLICATION

The present application claims priority to U.S. Provisional Application No. 62/165,563, filed May 22, 2015, the content of which is hereby incorporated by reference in its entirety.

### TECHNICAL FIELD

Embodiments described below relate to computer systems utilizing knowledge-based models. More particularly, embodiments disclosed below relate to knowledge representation, knowledge accumulation and knowledge communication. Embodiments described herein may also relate to Database structures for information retrieval, and file system structures in structured data stores.

Further, embodiments of the present invention transform words, numbers, graphics and their associated computer codes into dynamic semiotic systems and forms that can include interactive dynamic systemic semiotic models and interactive dynamic systemic semiotic model-based interactive worlds composed of standardized ontological groupings of variables and subvariables signified in certain embodiments as families of unique shapes and cells with subvariables represented by layers of unique macro to micro subcells and subshapes, all filled with dynamic organized languages of robust and adaptable color, pattern, action and interaction that convey cognitive semiotic meanings that can signify systemic understanding, multivariate understanding, complexity, dimensionality and perspective. These variables and subvariables can be determined according to the objectives of an originator, user, moderator or agent using a dynamic range of sensory multimedia including visual, auditory and kinetic, for example.

### BACKGROUND

Human beings experience, think and act in large part through the narrow lens of their language and language populated media and internet. Human beings interact with their computers and computer aided networks also through the limited mechanisms of their language and the mathematics, icons and graphics that apply the language. Computer programmers and engineers either translate language into compiled computer languages or computer languages into forms of human language as interface or output.

Human evolution has proceeded without the benefit of a truly systemic lens, one which could enable anyone to perceive, communicate and understand knowledge as the multi-layered, multi-variate, multi-dimensional construct that it is. Existing forms of individual and mass communication rely heavily on written and spoken symbols, (words, numbers and graphics), inherited through centuries of unplanned cultural iteration and diversity of form. Language uses words and other linear or fixed in place signifiers as narrow building blocks and cannot represent a whole systemic idea, construct or complexity until all of the blocks are in place. Even then, the user is limited to imagining a one- or two-dimensional representation that is inherently, cognitively and physically incapable of communicating the complexity of multivariate data and knowledge, changing across time, space, perspective, context, interaction, input, levels of detail and micro to macro scale. The study of such representations of data, translating complex concepts into symbols and structures that are understood in such terms is called semiotics.

One problem pervasive throughout legal learning systems of the world is that there is no ubiquitous semiotic mechanism for one to create, accumulate, interact with, communicate and apply structures, universal forms, scaffoldings, arrays and multi-dimensional perspective views of the verification, validation and derivation of science based, logic based, reason based proofs, which inhibits transparent, collective, accumulative and summitive proof and information analysis.

Standard attempts to develop and display proofs include theorems, algorithms, mind maps and decision trees. But no standard approach uses forms of computer communication that transcend the linear barriers of culturally diverse languages, no approach is interactive, dynamic, multi-dimensional, comprehensive and universally applicable, and no form of media represents and displays the relationships and validations of all of the variable sets or the scaffoldings of synthesis, derivation, and consilience that lead to various levels of proof. Further, no mechanism for proof exists that approaches the solution sets and culminations in a way that acknowledges complexity and the capacity of dynamic semiotics to signify the pursuit of proof and valuing systemically, across all relevant variables, variable ontologies and spectrums, viewpoints, layers and dimensions of knowledge, validation, sources, alternative derivations and explanations, diverse evidence and the absence/uncertainty of knowledge.

Another pervasive problem throughout all forms of human organization, human commerce, human transactions, financial systems, investment systems, learning systems, governments, currencies, marketplaces and enterprises is the lack of a ubiquitous mechanism for valuing and reward that is easy to use, systemic, fairly perceived by all, continuous, omnipresent, and designed for universal adoption.

Language itself is inherently incapable of addressing systemic complexity-manifold variables interacting in complex ways across time, space and perspective. Embodiments described in the present application relate to similar subject matter as U.S. Pat. No. 8,482,576 (filed Apr. 16, 2012), by the same inventor, the contents of which are incorporated by reference herein in their entirety.

Therefore, there is a need for new ways to tame complexity and enhance the capacity of language, communications and computer systems. There is further a need for a system that can be used by anyone, regardless of inherited languages, cultures, or educational levels, to promote science, culture, progress, problem solving, and the pursuit of truth, proof, and valuing.

### GLOSSARY

Semiotics: the mediated representation of meaning, the direct and indirect ways life forms communicate information, linguistics and the constructs that signify thought, perception, expression, perspective, sense making and cognition.

Dynamic Systemic CyberSemiotic Compiler: synchronized computer aided visual, auditory and touch manifestations that function simultaneously as a computer interface and translator, as a high level multi-directional compiler and semiotic transformer, as a semiotic software engine, as a new representational form of systemic human language and as specific or accumulative mechanisms for the capture, organization, storage, search, retrieval, input, output, access and moderation of systemic meaning.

Dynamic Semiotics: an inclusive and robust continuum/spectrum of forms of Semiotics (e.g., semantics, syntactics, pragmatics, signs, signifiers, representations, symbology), including Cybersemiotics, Linguistics, NeuroSemiotics, Computational Semiotics, Design Semiotics, Music/Sound Semiology, Visual Semiotics, Structural Semiotics, Biosemiotics, Active Semiotics, Fixed Semiotics and Cognitive Semiotics. While the emphasis of dynamic semiotics is with changing visual, auditory and touch patterns within accumulative ontologically derived frameworks and templates—snapshots, samplings and simple fixed in space and time summary forms/icons/avatars/representations of in-motion semiotics are an important and necessary part of dynamic semiotics. Words, sounds and printed or displayed graphics are semiotic forms that are found at the lowest range of dynamic semiotic instantiation.

Semiospheres: a type of Dynamic Semiotics which signify and integrate human self-centric environments with all environments external to the self. The creation of “digital worlds” such as those found in the deepest and widest interactive computer video games are one among many ways to instantiate semiospheres. Semiospheres are semiotic sense based worlds ontologically organized and composed of but not limited to maps, models, patterns, constructs and dynamic interactive systems of knowledge, perspectives, relationships, states, meanings, compilers and instantiations designed to fulfill the originator's individual or accumulative objectives and the user's individual or accumulative objectives via robust comprehensive interactive semiotic forms and mechanisms.

Cybersemiotics and Biosemiotics: the evolving science and neuroscience breakthroughs that depict the memory, cerebral functionality, cellular and organ functions and systemic organic functionality of living organisms to in part rely on dynamic semiotics for mechanisms of information storage, retrieval, stimulation, perception, cognition, signal creation, signal transfer and communications, signal reception, complex interactions and transactions, code based behaviors and cause effect transactions. Geographically organized patterns and forms of matter and energy, acting across place and time, compose key elements of content, meaning, action, transaction, intelligence, autonomic function, sustainability, change and state throughout the complexity of an organism. The use of cybersemiotics and biosemiotics realizes the synchrony between and among cognitive brain function and cognitive semiotics, matching how the mind processes input with how the present invention outputs and communicates with the mind. Such cognitive mechanisms of the brain such as cells, synapses, dendritic spines, neurons, basal ganglia, proteins, cerebrum, cortex, and limbic system are represented semiotically in order to better match and optimize dynamic semiotic output with how the brain and mind work, and to extract and mimic the extraordinary capacity of brain function to process information and complexity through the various forms of dynamic semiotics defined in the present invention.

Reality, knowledge, proofs, marketplaces, communications, states, exchanges of value, tokens, relationships, systems, and meaning can be constructed, represented, accessed, shared, traded, and learned about not only through the current use of language (words and numbers, icons, graphics and data) but through the present invention which may in certain embodiments incorporate transformational formats, physical manifestations, mechanisms, media, technologies, software, compilers, art, networks, foundations and processes that may include but are not limited to the following contributing forms and variables:

Dynamic and cybersemiotic frameworks, structures, processes, digital worlds, languages, medias, mechanisms, interfaces, displays, visualizations, patterns, sounds and touch that may extract, create, accumulate, process and combine these variables and constructs include science, empirical collection and reasoning, replicable observation and research, validated knowledge, logic, proofs and mathematics with genetic programming, biology and neuro-science, bio-semiotics, cognition, life experience, perspective, objective, culture, and the social sciences, linguistics, cognitive semiotics, cognition, educational psychology, language studies, self-programming, plus the structures and content of living systems which include human institutions, human constructs, human exchanges, human evolution, human organization, corporations, government, human economic and social systems, plus complexity, systems, relationships, changes, objectives, states, feedback loops, senses, perspectives, layers of detail, scale, time, interactions, transitions, transformations, accumulations of information and knowledge, decisionmaking, optimization, sustainability, nurture, equality, the pursuit of truth, consciousness, subconsciousness, autonomics, autopoietics, meaning, computer and communications devices and digital networks and mechanisms, motion, yardsticks of measurement, among others.

### SUMMARY

A set of tools, software, compilers, engines, methods, agencies, processes, physical manifestations, and applications of sensory media for the integration and transformation of words, observations, interactions, information, data and information graphics into accumulative dynamic and cybersemiotic forms of systemic communication and understanding is described herein.

In one embodiment, the tools, methods and applications are deployed in and through an interactive computer network or on a display/input screen, sound system, virtual reality and mixed reality system, 3D sensory system, sensory system, performance or projection such that users can independently or collaboratively create, contribute to, store, search, browse, mediate, observe, access, interact with, extract, print, output or apply accumulative, summative and/or transactional systemic or contextual knowledge in the form of cybersemiotic communications and dynamic systemic semiotic environments utilizing visual, auditory or touch sensory communication mechanisms and cybersemiotic compilers.

In one embodiment, the proof process and valuing systems comprise a software engine, cybersemiotic compiler, and semiosphere configured to allow a user to represent and understand a complex proof process and valuing system in a semiotic environment, wherein the semiotic environment comprises a multivariable system. In one embodiment, the interactive semiotic communication system comprises a toolset composed in part by a semiotic ontological framework and accompanying dynamic semiotic representations that may function as a complete checklist of variables, factors, and systemic relationships. In one embodiment, the interactive semiotic communication system comprises a dynamic graphical, tactile and auditory user interface, accessed on a computing device interface configured to allow the user to access by touch, keyboard, mouse, motion, voice, virtual reality and mixed reality system, 3D sensory system, or controls and select an item from the toolset and otherwise interact with the dynamic complex system and the computer system in the semiotic environment—organized in embodiments of form, pattern, position, motion and function for maximum human cognition. The software engine of the interactive semiotic communication system, and the semiotic compiler, in one embodiment, are implemented on a computing device with a processor. These and other various features and advantages that characterize the claimed embodiments will become apparent upon reading the following detailed description and upon reviewing the associated drawings.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Subject matter hereof may be more completely understood in consideration of the following detailed description of various embodiments in connection with the accompanying figures, in which:

FIG. 1 is a diagrammatic representation of an embodiment of a screenshot key that defines across the top model set four colors that may in one embodiment of a dynamic semiotic proof process identify a continuum.

FIG. 2 is a diagrammatic representation of an embodiment of a screenshot shape and form key that defines in one embodiment of a dynamic semiotic model set ontology of shapes and forms.

FIG. 3 is a diagrammatic representation of a screenshot of one instantiation of a dynamic semiotic systemic ontological multi-layered model set of a human being, according to an embodiment.

FIG. 4 is a diagrammatic representation of a screenshot, using the general framework of the embodiment shown in FIG. 3.

FIG. 5 is a diagrammatic representation of a screenshot of one embodiment of a dynamic semiotic systemic ontological multi-layered model set of the principles.

FIG. 6 is a high-level diagrammatic representation of a screenshot of one embodiment of a proof process systemic in context.

FIG. 7 is the equivalent of a block diagram embodied in a dynamic systemic semiotic format to communicate the systemic relationships among certain variables.

FIG. 8 illustrates components and relationships of an embodiment of a multi-layered semiotic systemic dynamic ontological model set.

FIG. 9 is an illustration of a two-dimensional proof model set, according to an embodiment.

FIG. 10 is one embodiment of a two dimensional view of a color filled proof model set showing the systemic progression of proof about the safety of certain ingredients in aspirin with raw data summaries in the upper set and derived summative conclusions in the lower set, signifying that certain components of this aspirin contain harmful ingredients—with the full documented evidence hidden beneath each colored cell in the form, in one instantiation, of perpendicular proof pyramids that summarize and link to all source documentation, with any singular single cell color in FIG. 10 serving as the summative tip color of the derivation proofs below.

FIG. 11 illustrates how multiple proof model sets can be organized spatially to represent systemic connectivity. In this instantiation, proof 1 connects to proof 2 within one plane, and proof 1 also connects at the tip to a single pixel (cell) of proof 3, whereby the color and pattern of proof 1 at its top cell (pixel) becomes the cell (pixel—complete with color and pattern) of proof 3 at spatial location 4.

FIG. 12 is a screenshot illustrating an embodiment incorporating two- or three-dimensional controls, semiotic input toolsets, labels, and semiotic timeline histories of model set inputs and dynamic events along with documentation links for proofs and valuing.

FIG. 13 consists of a screenshot showing detail of one embodiment of the creation and display of semiotic timeline histories of model set inputs and dynamic events along with documentation links for proof and valuing.

FIG. 14 is a screenshot illustrating one embodiment of a grouping of ontologies for proof or valuing by spatial position, shape and relationship at a high level view. The embodiment depicted in FIG. 14 does not include any subcellular structures, layers, dimensions, colors, patterns, motion or multisensory characterization. This type of model set, since it has a distinctive use of shapes and forms, can become an easily recognized universal model set because of its unique visual and spatial composition.

FIG. 15 is a screenshot illustrating one embodiment of a high level semiotic systemic grouping of variables within one or more ontologies.

FIG. 16 is an illustration of a highest level model set according to an embodiment.

FIG. 17 is an illustration of a model set nested within the embodiment of FIG. 16.

FIG. 18 is an illustration of a model set nested within the embodiment of FIG. 17.

FIG. 19 is a screenshot of a high level semiotic valuing system within a systemic contextual semiosphere, according to an embodiment.

FIG. 20 is an illustration of one embodiment of a valuing model set filled with high level cells and simple color and pattern.

FIG. 21 is an illustration of one embodiment of a proof process model of the present invention, set within a portion of an interactive semiosphere that possesses the characteristics of a video game world.

FIGS. 22-25 depict simple 2 dimensional screenshots of embodiments of dynamic cycbersemiotic modelsets that rise to the level of semiospheres. These semiospheric instantiations provide examples for those skilled in the art concerning how the highest levels of various modelsets can be put together in one view so that any originator or user can experience multiple high level variables and perspectives and scales through the holistic appreciation of how the patterns within the high level modelset cells signify which variables are in play, how and to what degree, and what the system meaning is from the whole view

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Described below are a plurality of embodiments of processes and systems for conducting comprehensive proofs and comprehensive valuing. Embodiments of the claimed invention resolve several problems of conventional systems.

First, embodiments described herein can be accumulative. An “accumulative” system is one that builds upon itself, and also modifies itself in real time. By implementing such systems on networked, computerized systems, cybersemiotic systems can be constructed that enhance access to the latest models, proofs, and information in real time (i.e., omnipresence).

Second, embodiments facilitate dissemination of information in novel formats and non-verbal semiotics that overcome obstacles with language-based information representations. Through semiotic representations, many language barriers are removed. Users can define semiotic representations and queries that draw from a vast store of information independent of language.

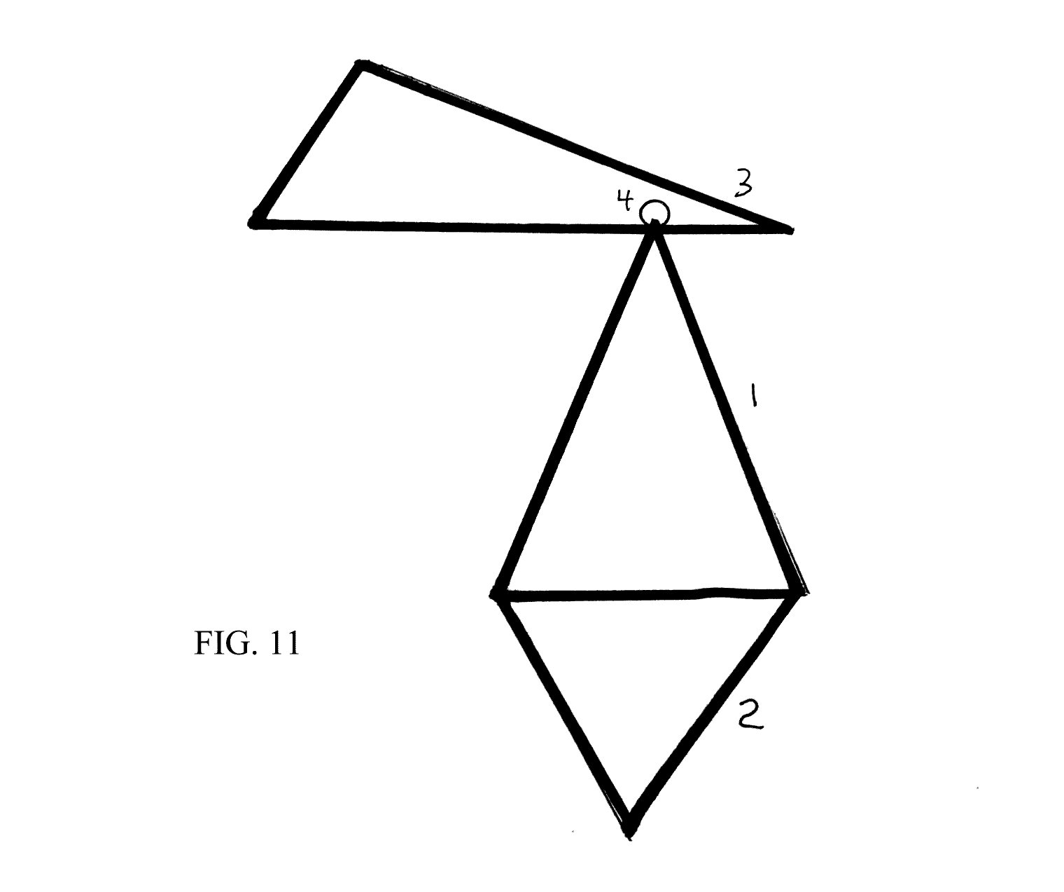

Third, proofs can be constructed from multi-leveled trees. For example, as shown in FIG. 11, a single element in a test to determine the answer to a particular question can be predicated on the answer to a separate question, which can in turn draw from a large body of tiered syllogisms, data, or other semiotic representations relating to that particular proof or question.

In one instantiation, we address the realities of complexity by introducing schemas, methods, compilers, software, patterns, forms, toolsets and physically and sensorially manifested mechanisms that cumulatively and interactively overlay, synergize with and possibly replace the prevailing non-systemic language driven semantic, iconic and graphic communication processes.

For example, in one embodiment we apply the emerging fields of cybersemiotics, biosemiotics, neurological imaging and mapping, cognitive semiotics and dynamic generative multimedia software and compilers to the development of new modes of human to human and human to computer two way communications.

In another embodiment, we introduce a robust, cross-cultural, dynamic ontologically organized cybersemiotic process and mechanism using specified yet robust and collaboratively derived shape, color, sound, pattern, touch and motion to express systematic categories of simple and complex meaning in different domains layers and dimensions, driven by an interactive and accumulatively generative multimedia software engine and compiler that can dually receive and create manual, semi-autonomous and autonomous knowledge through dynamic semiosis—representations of meaning.

Only recently has technology evolved to realize the software, real-time processing capacity and paradigm shifting potential of various forms of semiotics to conceive and create new mechanisms that provide the engines, compilers, tools and processes to effectively communicate complexity, systemics, multi-variate time/space relationships, transactions, relationships, interactions, states, transformations and the overwhelming progression of real time information and real time problems. Some such systems are described in U.S. Pat. No. 8,762,315, the contents of which are incorporated herein in their entirety.

In one embodiment, the proof process may be a generative dynamic computer system for the accumulation, documentation, synthesis, derivation and display (2d, 3d, 4d, print, media, sculpture, sound, touch) of comprehensive proofs of any subject according to an optimized for an objective. The proof process includes but is not limited to participative and mediated input, content storage, browsing, search and retrieval, and a robust multisensory semiotic user interface and environment built around assigned patterns, ontologies, processes and worlds. Semiotic representations of meaning may include bio/physio-mechanical generative “living” models and video game like worlds, and a visual and auditory compiler that translates information, logic, algorithms and objectives into cybersemiotic meaning at the highest levels, and into proof protocols, sourcing, validity, links, object code, machine language, references, citations, variables, documentation and raw data at the lowest levels.

Some of the technologies and processes and art-forms that together define our present invention's application of a Dynamic CyberSemiotic Systemic Knowledge Compiler are described herein. In one embodiment, they solve the problem of how to build a system and scaffolding of knowledge that documents and directs the user toward derived proofs and verifications of what is known to be accurate and validated, and what is not, and why. These processes also solve the problem for the user, who wishes to utilize an application of art-forms and computer aided toolsets and personal/mobile computers and server networks to browse, search, achieve an objective, or obtain and contribute to the most complete and accurate proofs at any level of any component of human understanding. Embodiments of a dynamic semiotic communications system can be ubiquitous—from textbooks to the internet, from print publications to electronic databases and media, from human communications with paper and pencil to simple hand-signs and symbolic language shortcuts, from juries to decision-making, from voting to medicine, from law to science, from governing to leading, from guiding one's daily choices to guiding the choices of the world's largest organizations.

Embodiments of the claimed invention create a dynamic cyber-semiotic mechanism that enables the accumulation of knowledge into families of systemic ontological modelsets that can be created and accessed as part of the semiosis—a family of semiotic modelsets and environments that we call semiospheres. In order to comprehensively appreciate the context and dimensions of proofs and valuing, it is necessary to provide a complete environment of information, knowledge, and perspective consisting of all variables and variable relationships applicable to an understanding of any knowledge, proof or valuing.

Embodiments of the claimed invention resolve the problem of describing systemic complexity without language, by introducing the invention of a dynamic higher level computer aided semiotic compiler capable of feeding computer language and human language, including code, numbers, graphics and data into a physically manifested mechanism and compiler tuned to human cognition that is capable of signifying complex meaning, knowledge and exchanges.

There is no form of communications in the world that systemically, dynamically, and semiotically addresses and applies models, processes, languages, media, and communication mechanisms for the sourcing, research, documentation, storage and retrieval, construction and verification of the proof of anything complex.

Standard attempts to develop and display proofs include theorems, books, algorithms, mind maps, line drawings, text and chart slide presentations, data visualizations, and decision trees. But no standard approach uses forms of communication that transcend the linear barriers of geographic languages, no approach is interactive, dynamic, multi-dimensional, systemic, comprehensive and universally applicable, and no form of media represents and displays the relationships and validations of all of the variable sets or the scaffoldings of synthesis, derivation, and consilience that lead to various levels of proof. Further, no mechanism for proof exists that approaches the solution sets and culminations in a way that acknowledges that everything is complex and that everything important can best be understood systemically, across all relevant variables, variable ontologies and spectrums, viewpoints, layers and dimensions of knowledge, validation, sources, alternative derivations and explanations, diverse evidence and the absence/uncertainty of knowledge.

Deploying a comprehensive, dynamic, systemic, semiotic, universal participative multimedia representation of proof content, validation, variables and variable relationships, logic, reason, synthesis and conclusion across every layer, dimension and perspective would enable any contributor or user to access a portal of knowledge organized and accessed by but not limited to text query or interactive navigation (computer screen, touch screen, virtual reality and mixed reality system, 3D sensory system, keyboard, mouse, controller, motion, audio command, ocular interaction etc.) matched to the expressed objectives of the user. At the highest level, the proof process semiotically communicates the relational scaffoldings of validated knowledge, missing knowledge and un-validated hypothesis while transferring the highest value meaning of the proof composition to the user while also containing an easily navigable mechanism for the user to access and extract knowledge at any place in the proof, at any level of detail or granularity, from any media form, or to contribute knowledge to the proof.

Further, any Proof Process output can be simplified from dynamic interactive computer visualizations and audio-maps into fixed images and even hand sketches using the conventions, keys and protocols of Proof Process so that instantiations of the Proof Process, and outputs of the Proof Process, do not require a computer or access to a computer to benefit from the proof process's models, semiotics, schemas and processes.

Embodiments of Proof Process include but are not limited to extensive software applications that enable and empower massive or directed internet and computer network extractions or solicitations of knowledge, essentially the generation of new knowledge or the capture of expert or firsthand knowledge, directly through a semiotic compiler or indirectly through manual, mediated or semi-autonomous semiotic translations that contribute to the evidence and formation of a Proof.

Described herein is a system of dynamic tools, accumulative semiotic forms, software, semiotic compilers, controllers, art, processes and conventions that can reduce or eliminate the suffering of millions of people and the failure of social, scientific and commercial communities to effectively and comprehensively address the complexity of massive non systemic, poorly validated inputs of data and information and the potentials, challenges, understandings and opportunities presented by the present invention of a dynamic accumulative systemic semiotic compiler capable of organizing and communicating proofs, proof processes, multiple variables, valuing, value exchanges within the context of comprehensive environments of documented knowledge.

Quite literally, a computer driven Proof Process and Valuing System that can in any or all of its instantiations become the convention and systemic toolset for verifiable transparent interactive social, commercial and legal proofs and value exchanges across the globe will change the nature of belief and understanding, improve the capacity of human beings to comprehensively learn, teach, plan, communicate and process anything important or complex.

The Proof Process System of the present invention is founded in part on a series of constructs that include but are not limited to:

Systems: The proof process's composition of proof contains, but is not limited to, a nano to macro scaling of layers, dimensions and selections of viewpoints populated by grouped sets of dynamic semiotic variables that act and interact across time, space using semiotic compilers of patterns and forms and sensory media. One embodiment of the invention is a comprehensive way for humans to experience, process, synthesize, comprehend and apply the multivariate, multidimensional factors involved in any proof of anything complex is to define the n number of relevant or possibly relevant variables, label them and organize them, and then place them into semiotic ontological spatial arrays that identify, translate via semiotic compilers, and communicate how to best synthesize the variables and variable relationships into systems of understanding so that the details, while easily cognitively perceivable sensorially, can be synthesized in meaning at any level or viewpoint and applied to comprehensive verifications of knowledge and determinations of proof. For example, a person with a diagnosed disease will want to examine how the systems associated with his/her disease work, including contributing factors, cause/effect, research, expert opinion, patient opinion, personal history, treatment options, chemical and biological processes, alternative viewpoints etc.

Objectives: The present invention's Process's Proofs can in one embodiment be driven by the objectives, experiences and skill sets of the contributors and by the objectives of the user. Objectives are an important dimension of effective proof. The Proof Process obtains controls, manages, interacts with, validates and applies objectives. At the highest level, and at each level beneath and beyond, content associated with objectives can in one embodiment be configured into a relatively small N number of ontological construct variables that can be visualized as cells, bounded faceted models and model elements, textures, patterns, shapes, relative and absolute positioning in space and time, characteristics and for the user, controls that help define the interaction, navigation, search and outputs etc. For example, a user search for treatments for his/her disease wants to find the most effective, cost effective, least side effect inducing etc. treatment(s) along with the evidence and synthesis so that every component of the proof of treatment can be transparently and instantly processed for meaning—which in this case is deciding what to do.

Meaning: Ultimately, meaning itself at the highest level can be configured using the process, but not limited, into a small N number of essential variables, easily configured into semiotic representations of such constructs as good/bad, healthy/unhealthy, valid/invalid, accurate/inaccurate, numerous scales for decision-making, prediction and judgment, related/unrelated, cause/effect, factual/fictional and others . . . . For example a user wishing to examine a specific disease treatment, wants at the highest level to immediately know if there is substantiated Proof that taking a particular treatment drug is correlated with a specific or general side effect. The meaning the user seeks at the highest level can be instantly and effectively conveyed in one embodiment by a pattern coded visualization of the variables and systems associated with the disease, the drug, and alternative treatments according to side effect.

Proof: The process of the Proof Process described herein brings together in systemic form all of the constructs explained herein, and others. The Proof Process is designed to be robust, inclusive, participative, dynamic, flexible and accumulative, based upon user interaction, contributor interaction, and algorithmic self-learning. The kernel of Proof can in one instantiation consist of a continuum from a solid fixed foundation to a seed or seeds—designed to grow and adapt, and reorganize, according to contributors and users. The process' coding and controls can in one embodiment enable and empower users and contributors to shape the Proof Process and Toolsets according to their needs. The Proof can also be autopoietic or follow specific paths.

Proof can be defined as a never-ending universal human process of observing, experiencing, obtaining, verifying and synthesizing knowledge in a manner that is consistent with logic, reason, scientific method, human functionality and best practices in order to reach a trustworthy systemic understanding or conclusion. For example, jurors in a typical court have little or no education or guidance as to what constitutes the best process of synthesizing the plaintiff and defense presentation of evidence in order to reach a verdict consistent with the law and instructions. A Proof Process toolkit would serve as a checklist of variables and connectivity, of logic and reason, of validation and verification, to ensure at the very least that they miss nothing and foremost that they achieve an open and verifiably accurate, well documented conclusion that would stand up to the scrutiny of any open and objective evidence and logic oriented third party.

Educational Psychology: Human beings can be thought of as a three part intertwined ontology—Conscious, Subconscious and Corporal. How humans process the construct of Proof depends upon their genetics and heredity, their physical (corporal) functionality, their life experience, their subconscious processing and the processing that they retain conscious access to, recognition of and control over. Human beings cannot construct a fully objective, highly comprehensive, fully verified Proof without considerable help in the form of inclusive systemic knowledge and experience, a well constructed conscious overlay driven by the objective of pursuing truth and systemic understanding, and a process and toolset that enables and expedites how to consider and achieve a trustworthy Proof, or how to comprehensively analyze the Proof Process of another. Because human beings are genetically programmed to identify patterns and disruptions, the Process described herein utilizes the evolving art and science of semiotics, the representation of meaning through multimedia, which is the strongest channel available for humans to comprehend, work with, contribute to and apply anything complex. Visual and Auditory stimuli are tuned to how human beings process the world, and the Proof process fine tunes the optimization of art forms and science and technology. Additionally, the Proof process also is optimized for another critical factor in human learning and response which is interest. Human beings must be attracted to, entertained by, stimulated by, and rewarded by a system in order for it to be well used. The Process described herein utilizes pattern and color in order to create attractive interactive visual worlds that can self optimize according to a user's wants and needs while retaining features similar to video games that make the experience highly attractive and rewarding. Feedback loops built into the control systems create a connection with the users and contributors that emphasizes conscious and subconscious attractions that include recognition for use and contribution. Finally, humans are not wired to perceive or process systemic proofs so it is necessary to deconstruct complexity into bite size processable pieces while retaining and maximizing the whole picture and all of the dimensions and variables contained therein. Cognitive science evidence strongly suggests that human beings can only process or retain small amounts of systemic information at a time. Keeping comprehensible conscious and subconscious ongoing track of manifold variables across time and space, according to cause and effect, change, chance, validity, interaction and synthesis without the bounds of a proof is impossible for most people to accomplish. Research shows, for example, that doctors have great difficulty keeping track of the evidence supporting a particular diagnosis or treatment when the knowledge itself is changing rapidly. The only mechanism capable of overcoming these features of limited human capacity is taking full advantage of computers, connectivity and how humans perceive the world. Every Proof component, relationship and meaning can be available in an instant to the cognitive subconscious and conscious processes of a human if it comes in the form of pattern—visual and sometimes audio pattern, conveyed as a comprehensive language communicating variables, relationships and meanings through pattern, color, form, ontological grouping, linkages and dimensions and most importantly, meaning. One instantiation uses a vibrant bright red color to indicate that a variable is proven to be harmful to a patient under certain circumstances which are easily observed within the multimedia scaffolding of the process. For example, reading a book about multiple sclerosis will result in the retention of some information but viewing an active “living” screen filled with cognitive semiotic pattern and color that can easily be processed for high level meaning by the user and tailored to their specific search objective results in the delivery of a Proof (or a series of Proofs and Models) answering their question. If the user is looking for what is healthy, they can look, in one instantiation, for a bright blue color within the Proof constructions and observe the variables and if desired, all of the composed evidence, organized according to any desired format that support and verify the Proof

Language: Humans think, comprehend, perceive and believe according to our language, our life experience and our genetic programming. Words alone pose extreme barriers to the systemic understanding of anything, and particularly proofs. Barriers include literacy, education, the hundreds of different languages throughout the world, specific highly developed specialty languages such as scientific and legal languages, and the linearity of form that makes it very difficult to explain anything systemic to anyone. The proof process, in one instantiation, creates a new high level multimedia compiler, like high level computer code, except in this case the high performance languages of this process work between and among humans, between and among humans and computers, and between and among the nano and macro dimensions of proof and the synthesis and systems underlying proof understanding. For example, a person without literacy, without a language that can translate from the source language, without education, can, in one instantiation of the process, identify the meaning of a proof via pattern and form to the extent that they can make an informed trustworthy decision based upon the proof representations on the basis of what they see and hear.

Semiotics: Semiotics refers to the representation of a construct through symbolics. While words are a crude form of semiotics, fully developed structured models and environments operating in visual and auditory domains can capture, store, retrieve, express, communicate and display understanding and meaning in symbiotic relationships with the aid of words and images or as a standalone mechanism, or something in between. The proof process of the present invention exploits the science and technology of cognitive semiotics into new territory by embracing, in one instantiation, the capacity of code and computers to operate real time highly sophisticated pattern, form, color, sound and motion based representations of the variables and relationships that compose a proof. At high levels of discourse, the semiotics contained within this process can, in one instantiation, immediately communicate the relevant variables and the meaning of a proof to the extent that the user can make a trustworthy decision or, in another instantiation, the user can use the semiotic forms to navigate beneath and around the higher level semiotics to experience detailed layers such as source documentation, for example, in the form of words, that are visually linked to the higher levels and conclusion levels and peripheral models and perspectives.

Ontologies: The process described herein uses visual and auditory ontologies, in one instantiation, to express by their shape, number, composition, position, form, pattern and change, for example, the variables and relationships of one or more proof constructs in a manner that can be instantly understood by a user skilled in the art and science of ontological semiotics, or a user unskilled in the art and science. Visual ontologies are formed, in one instantiation, to represent a limited array of variables that comprise a grouping at whatever level and perspective view is under consideration. The shapes, positions, size, patterns, textures and all other communicable elements of the ontologies define the construct set and enable the contributor or user to enter the set, view all related sets at any level or perspective, and immediately understand some of the relationships among the variables in the set, including but not limited to dominant vs. secondary, associations, linkages, scales, features and functions. For example, the human being can be represented at the highest level by a circle divided into 3 equal slices which represent the conscious, subconscious and corporal elements and within each ⅓ are numerous arrays of sub-ontologies consisting of cells representing each variable in the array at the level of detail and perspective desired. A single high level ontology, can, in deep instantiations, contain more than 10 levels, and can represent nano layers to macro layers and all variables and variable sets within. The shapes of the ontologies are designed according to their meaning and according to the science and psychology of how human beings perceive and understand shapes and the relationships among shapes. The ontologies are controlled by on screen drawing tools that can make them active and alive in an unlimited variety of ways in order to represent the characteristics that best correlate with meaning. For example, the exterior membrane of a cell can ripple and flow and appear porous in order to identify that variable in a proof as being dynamic and easily affected by neighboring variables in the array, or possibly below or above the array according to dimension and perspective. In one instantiation, every change to an ontology by a contributor can be mediated and edited, can be recorded and documented according to, but not limited to, time, date, user, verification, base model or alternative model assignment, derivation for the change etc.

Media: Knowledge can be originated, organized and communicated across the senses of sight, hearing and touch. In one instantiation of the proof process, any and all forms of semiotic media can be accessible and available within the embodiments of the present invention. Words, dynamic semiotic representations, spatial relationships, patterns, images, moving pictures, sounds, art, music, tactile feedback loops and more can be present within the capture, creation, organization, communication and utilization of proof process model sets, valuing model sets and the semiospheric environments that envelope or synergize with specific models. While a single color pixel may represent meaning in one instantiation of a dynamic semiotic proof process another instantiation may involve the proof by movie documentation and replicated demonstration of a specific fact, supporting the end result that may be represented by a single colored pixel signifying the highest level of validation and verification.

Pattern: In one instantiation, every ontological cell, every cell and ontology membrane, and the complete environment on screen can be filled with every visual, auditory and tactile attribute possible in order to convey meaning. The Proof Process, in one instantiation, limits the options of pattern and in certain embodiments defines a limited range of patterns that correspond to a key of meaning. The patterns can be fixed or moving, can have color and texture, can cross cell and ontological membranes, can be placed by the contributor using manual drawing tools or can be automatically generated based upon the semiotic compilers and/or the algorithmic rules and relationships coded into the system, or drawn into the system in order to compile and generate the code. Time sequences can be manually drawn or evolve autopoietically, animation sequences can be drawn or evolve autopoietically, all stored for generative or archived future viewing. The range of meaning through pattern using the proof process of the present invention can be extraordinarily comprehensive, and can include but is not limited to the following list and the combinations and interactions among the variables in the list, and beyond the list:

Patterns that the present invention may embody as mechanisms, compilers, and semiotic signifiers of meaning include but are not limited to:

(Visual or Auditory or Touch)

Color (hue, value, lightness, chroma, etc.), Size, Shape, Motion, Form, Continuity, Pulsation Directionality, Connectivity, Sharpness/Softness, Spatial Locations, Contrast, Change, Match/Similarity/Differentiation, State, Place, Speed, Decay, Emergence, Time, Transformation, Form, Function, Movement, Randomness/Predictability, Repetition, Interaction, Relationships, Tone, Loudness, Musicality, Pitch, Timbre, Harmonics, Echo, Rhythm, Scale, Zoom, Exchange, Transference, Overlays, Layering, 3D, 4D, Zones, Frequency, Arrays, Scaffoldings, Acceleration, Velocity, Gravity/Pull, Orientation, Sequence, Timeline, Slow Motion, Energy, Bonding, Opacity, Glow, Lighting, Angle, Dimensionality, Text, Add (Video, Text, Audio, etc.), Line, Line Flow and Line Trail, Textures, Mix, Saturation, Edit & Edit Trail, Creation & Creation Trail, Amplitude, Timbre, Resonance, Echo, Cadence, Canon, Beat, Consonance/Dissonance/Resonance, Energy, Dynamic, Harmony, Interval, Randomness, Modulation, Progression, Units/Strands/Threads/Fibers/Fabrics, Pitch, Cycle, Source, End, Unison, Geometry, Source Engines, Trajectory, Pitch/Roll/Yaw, Dynamics, Rotation, View Angle, Filters, Cycles, Parallax, Transparency/Opaqueness, Flow, Density, Proximity, User Initiated Interaction, Event Initiated interaction, Pressure, Force, BioGeography of Touch, Repetition, Progression, etc.

Semiotic forms that embody the present invention consist of but are not limited to shapes and the relative and specific characteristics and relationships of shapes (such as sharpness, curved edges, symmetry, continuity, proximity, similarity, x/y/z dimensions, x/y/z axis positioning, relative positioning, changes in forms, sizes of forms etc.) Each instantiation may be used in a certain manner to signify a certain meaning or class of meaning. Each form may be filled with dynamic moving colors and patterns and the edges of each and every form may consist of lines or membranes that are also dynamic, possessing motion and consisting of various semiotic attributes such as flow, color, relationship and pattern.

Optimization: In one instantiation, the dynamic semiotic proof process optimizes the system and experience according to the conscious, subconscious and corporal needs and characteristics of the contributors and users. For example, any user can choose to optimize for their perception of color which includes hue and chroma. The user can, for example, fine tune their perception of red so that if two versions of red are used to project meaning, with one version carrying greater intensity of meaning along a scale, so that any use of red for that purpose will adapt to their preferred versions of the color which include intensity or lightness, hue, mix formula, chroma and line density. In another example, a culture that identifies red as positive while the base Proof legend depicts negativity through the color red, the colors can be interchanged so long as the meaning is not lost. Other instantiations of optimization, but not an inclusive list, pertain to the selection of objectives from a predefined list of objectives so that the entire system will adapt to the selection of objective, the user's selection of higher or lower levels of detail, the user's preference for starting viewpoints, browsing via text entry or interactive visual touch/mouse/controller/ocular navigation through a world optimized by the preferences of the user. Optimization is implemented using the same mechanisms as the proof process itself, which include pre-constructed ontological arrays featuring the optimization choices grouped by category and appearing on screen as desired. In another instantiation, optimization can apply to the choices of proof model sets, correlated peripheral model sets and the shapes and forms of proof scaffoldings and perspective views.

Another instantiation of optimization in the present invention is the deployment of biosemiotic forms that match the semiotics produced by the present invention to the cognition, sensory perception and genetic wiring of human beings. Further, other instantiations of the present invention utilize the physical manifestations and functions of brain biology and memory to optimize communications and performance. As an example, the present invention may organize information semiotically into specific geographic areas, with each area containing small ontological cells within cells within cells, and when a specific construct requires an intensity to signal its impact on a systemic model, it may use forms such as dendritic spines and collections of neurons and proteins and patterns such as fast moving red lines to grab attention. Optimization may also include but is not limited to the selection of individual or cultural preferences across all of the semiotic instantiations of the present invention, with the self-learning software and semiotic compilers of the present invention capable of optimizing the originator, contributor and user experiences according to their needs and also according to the present invention's systemic measurement and feedback loops for optimization of cognition, multisensory semiotics, tools and controls, semiotic model set perspectives and creative contributions that advance the state of those skilled in the art and those less skilled in the art.

Real Time Generative Gaming Like Virtual Reality Like Code: The proof process includes, in one instantiation, but is not limited to, a sequence of programming languages, processor optimizations and bandwidth that enable the system to operate in real time or near real time using high level generative code that minimizes bandwidth and processor requirements while producing visualizations instantly for originators, contributors and users without resorting to traditional storage and retrieval. Instead, in one instantiation, the generative code sets are designed to regenerate form and pattern and environments instantly no matter what level, layer, perspective, model, scaffold or dimension is selected. Once the system base code has been initially launched, the system becomes autopoietic in addition to manual or semi-automated controls and can function as a cyber-semiotic compiler. When a contributor draws pattern or creates semiotics, generative code is automatically produced in the background along with the multiplicity of attributes, relations and meanings represented by the drawn (or audio or tactile) pattern. When a user selects that meaning set during search, the code automatically produces the original generatively coded sequence and adapts the entire environment toward the objectives of the user, anticipating via self learning software the related models and necessary controls so that they are readily accessible to the user. Even the act of manually drawing on screen can be, in another instantiation, semiotically compiled into code across all of the connective variables associated with the drawing. The originator may also manually touch and patternize each and every variable affiliated with the drawn variable.

Controls: Similar to the virtual reality controls of a gaming environment, the Proof Process controls enable, in one instantiation, originators, contributors and users to navigate, browse or activate the desired screen model-sets and worlds, select content ontologies to explore, drill down or zoom into specific areas, and accomplish objectives and tasks while guided by text controls, visual controls, auditory cues and tactile feedback loops.

Proofs at the highest levels may in one embodiment of the present invention contain an N number of known variables and an N number of relationships among variables that can be represented by bounded ontological cells and models and forms, which, when populated by defined translational meaning using colors and patterns within the cells, constitutes a proof or valuing model set.

In one embodiment, the present invention composes an inclusive comprehensive dynamic real time visual, tactile and auditory (semiotic) system of dynamic ontological progressions toward a proof process that captures and exposes all that is known about a topic or objective in a relational and representational way.

The Proof Process may in one embodiment contain technologies, software, semiotic compilers, processes and art-forms that together define a unique system of proof that solves the problem of how to build a system and scaffolding of accumulative knowledge that documents and directs the user toward comprehensive derived proofs and validations of what is known to be accurate and validated, and what is not, and why, based upon a universal participative mediated and automated computer aided network driven by the objectives of contributors and users according to standards that pursue truth in the most systemic and scientific manner possible.

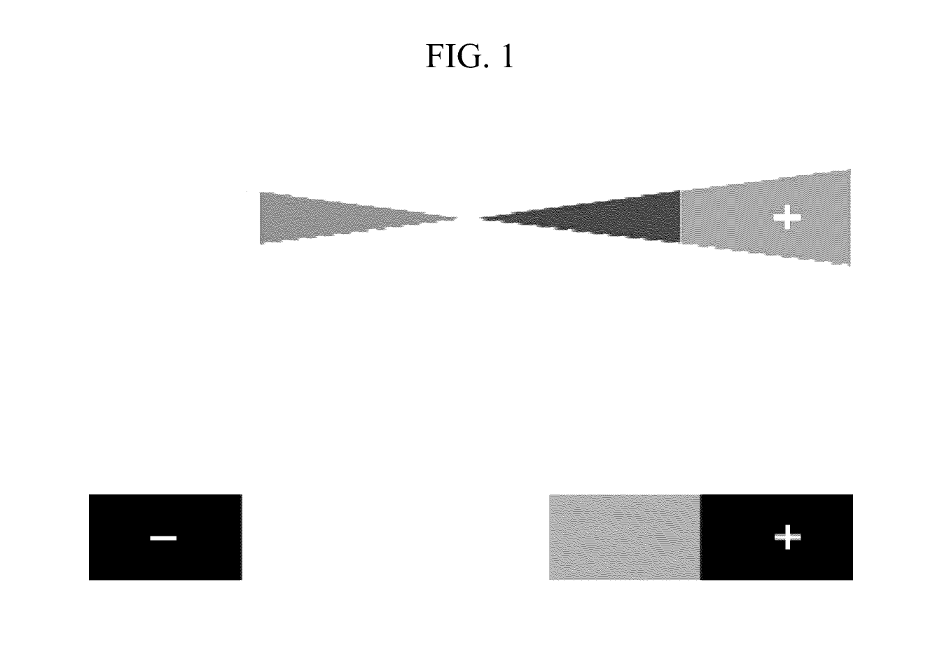

FIG. 1 is a diagrammatic representation of a screenshot key that defines across the top model set 4 colors that may in one embodiment of a dynamic semiotic proof process identify a continuum from left to right of highly invalid, probably invalid, probably valid, to highly valid with the colors in this example depicting a bright yellow, a dark mustard yellow, a dark green and at the far right, for the most validated semiotic key, bright green. The lower model set key, in one embodiment of the proof process, represents a five cell key continuum from left to right of highly negative (bright red), negative (pink), neutral or unchanging (grey), positive (muted blue), and at the far right, for the highly positive signifying color (bright blue). In one embodiment of the present invention, these colors represent a universal key to semiotic meaning when they fill a line, a cell, a pixel, an object, a moving object or the controls for the creation of semiotic visualizations. The present invention uses a similar schema of continuums to characterize meaning through sound, through touch, through kinetics and through other sensory mechanisms.

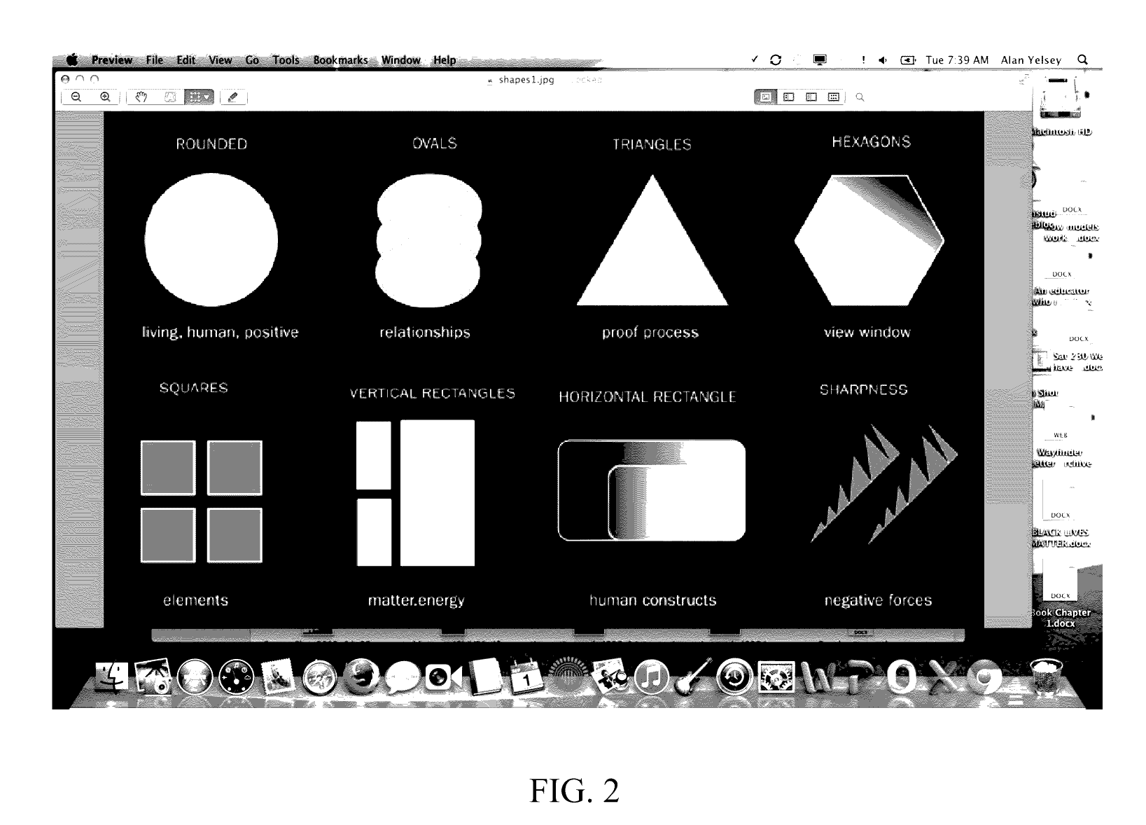

FIG. 2 is a diagrammatic representation of a screenshot shape and form key that defines in one embodiment of a dynamic semiotic model set ontology of shapes and forms signifying semiotic meaning constructs, with circular forms representing, for example, living systems, triangular forms representing proof process scaffoldings and hexagonal forms signifying multimedia communications portals. In order for dynamic semiotics to function most effectively as a high level systemic language, keys and schemas optimized for and adapted to universal human cognition are used to put order into the instantiations of meaning and in doing so, become an accessible high level systemic language for proof and valuing.

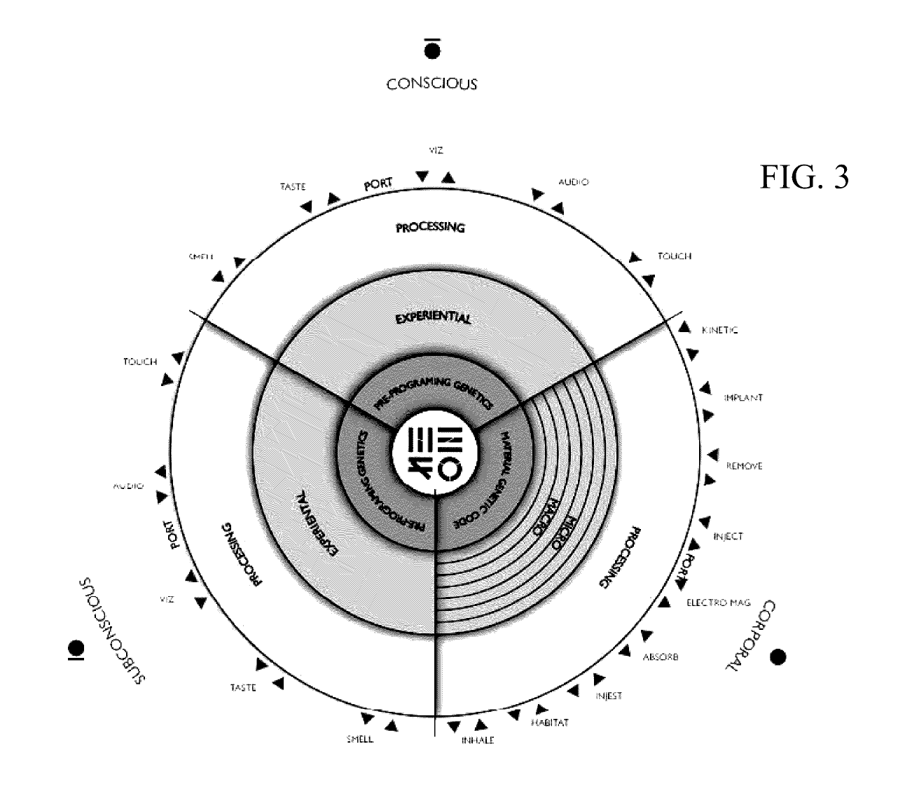

FIG. 3 is a diagrammatic representation of a screenshot of one instantiation of a dynamic semiotic systemic ontological multi-layered model set of a human being, organizing into conscious, subconscious and corporal sectors at the highest level of visual depiction. This view is at the highest level, with cells and subcells and subsubcells etc. not visible, nor are layers beneath visible, nor are colors and patterns within the cells and models visible.

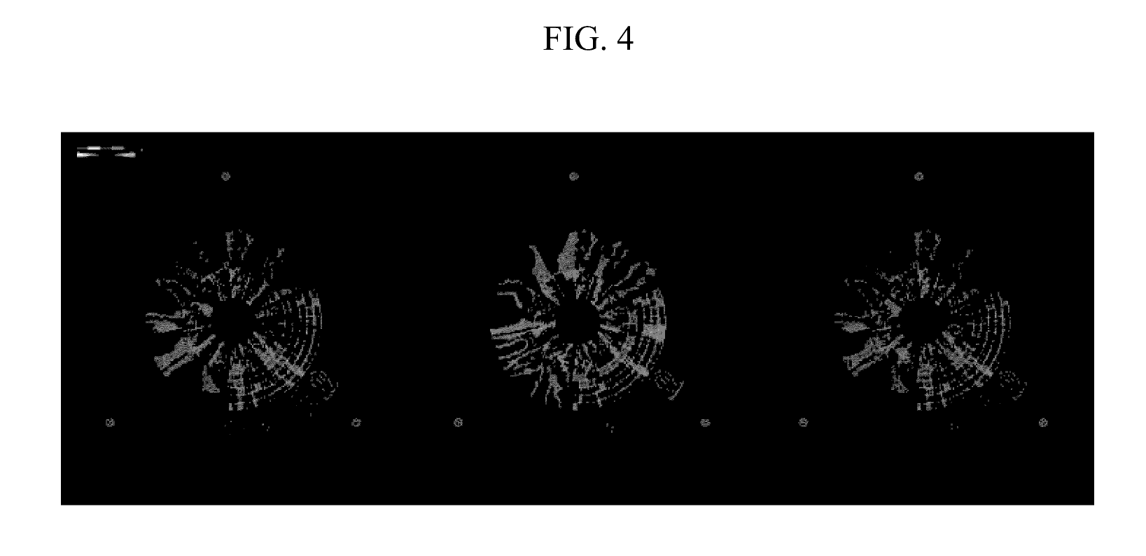

FIG. 4 is a diagrammatic representation of a screenshot, using the general framework of FIG. 3 model set, depicting the application of color to cellular ontological model sets at three instants across time, operating from left to right in time sequence. As a representation of the complexity of concussion, for example, the model set conveys meaning at the highest level of view, the one seen in this example, depicting a highly negative force damaging the brain (corporal) in the left model set which initiates a diverse set of systemically negative states to the corporal, conscious and subconscious of the human being represented in the middle model set, and culminating with the far right model set depicting latent damage (negative states) to certain parts of the corporal, conscious and subconscious of the same individual.

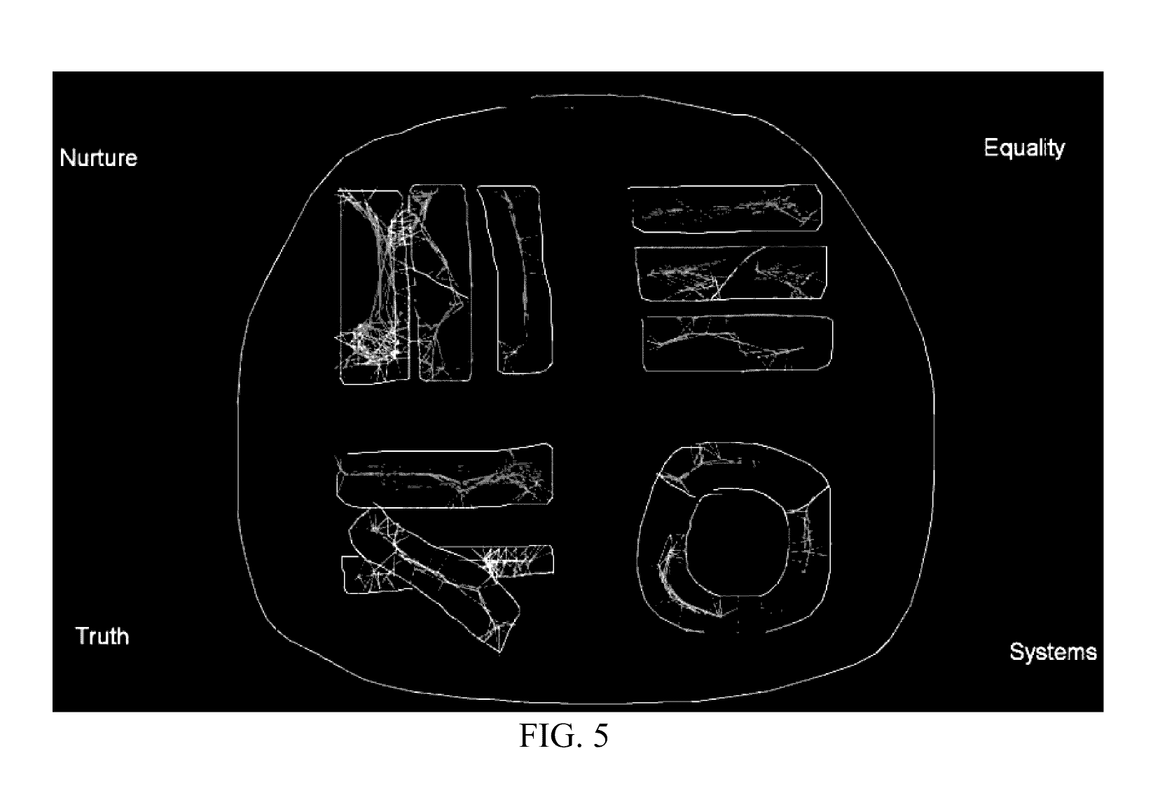

FIG. 5 is a diagrammatic representation of a screenshot of one instantiation of a dynamic semiotic systemic ontological multi-layered model set of the principles, objectives and constructs of Nurture, Equality, the Pursuit of Truth, and Systemics, organized in sectors at the highest level of visual depiction. This view is at the highest level, with cells and subcells and subsubcells etc. not visible, nor are layers beneath visible, nor are colors and patterns within the cells and models visible.

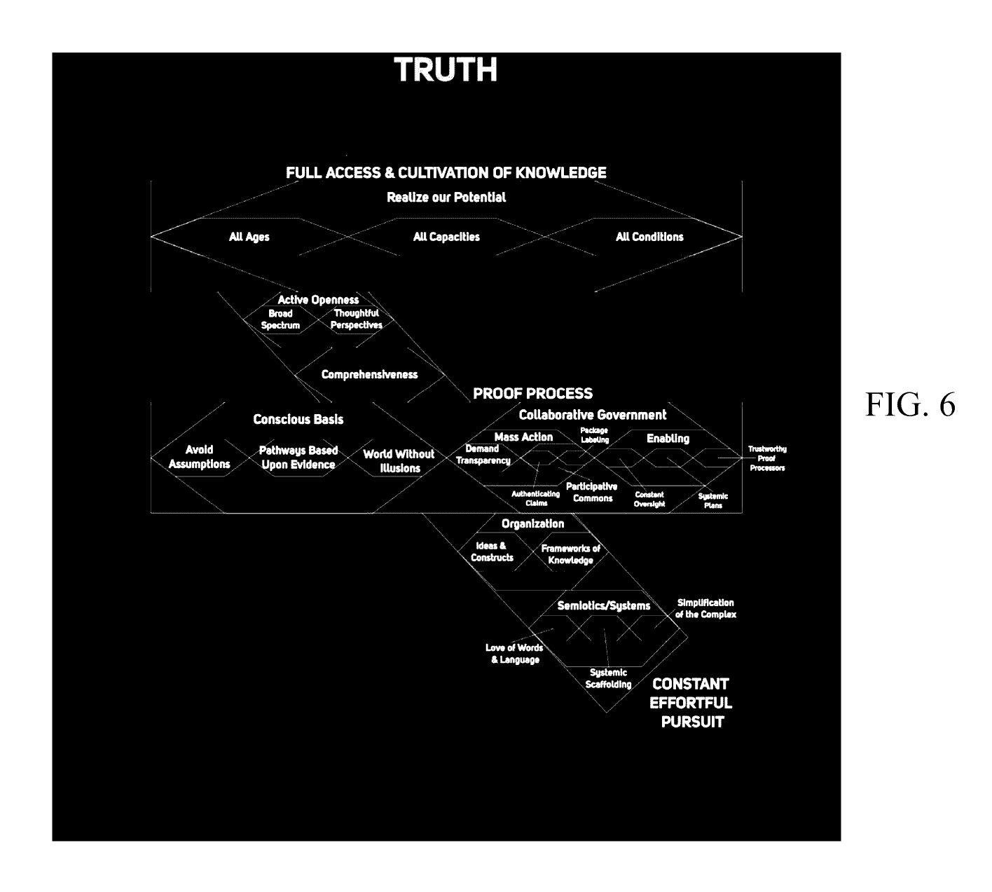

FIG. 6 is a diagrammatic representation of a screenshot of one embodiment of a proof process systemic in context, displaying at a high level some of the top layer of cells that represent constructs associated with the pursuit of truth, within which, in one instantiation, the proof process and valuing systems comprise subelements. This view is at the highest level, with cells and subcells and subsubcells etc. not visible, nor are layers beneath visible, nor are colors and patterns within the cells and models visible.

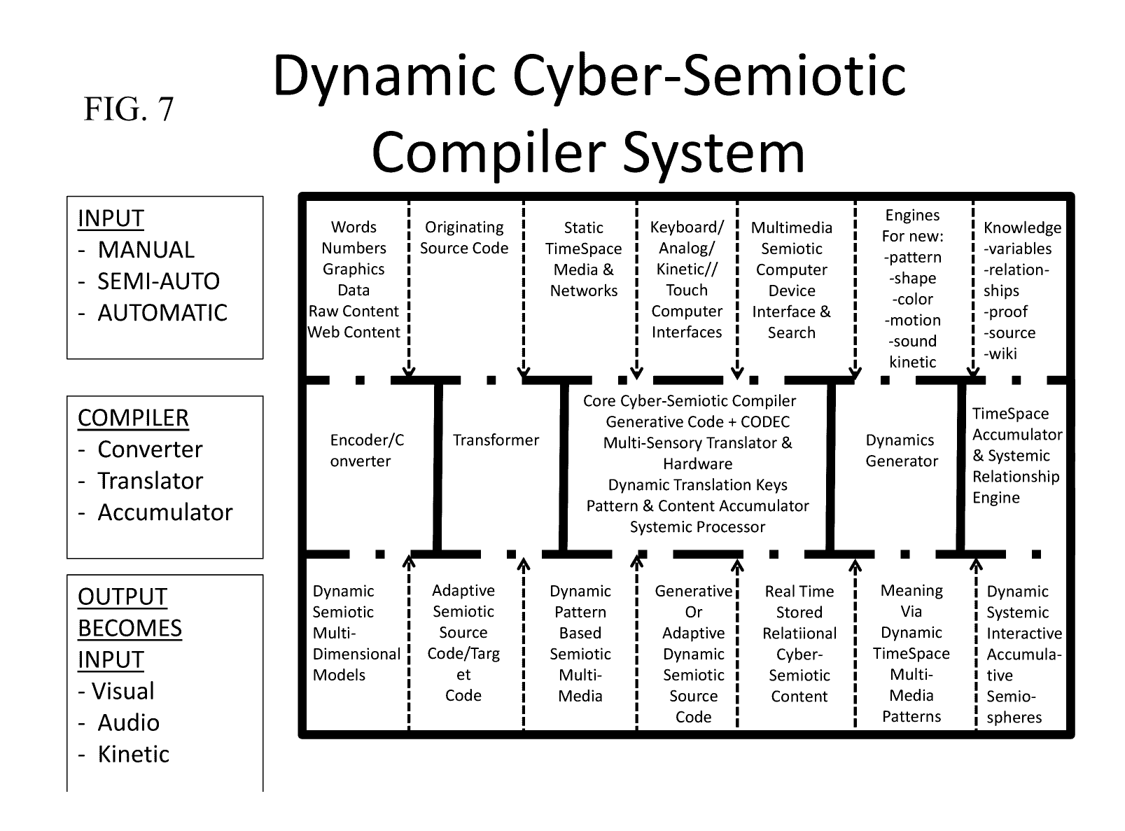

FIG. 7 is the equivalent of a block diagram of the present invention but it employs one embodiment of dynamic systemic semiotics to communicate the systemic relationships among certain variables of the present invention, and at the same time, this dynamic systemic semiotic offers one skilled in the art an example of the difference between linear line linked model sets and fully dynamic cellular and ontologically organized systemic model sets. One hemisphere of this embodiment of the present invention model set represents inputs, the other hemisphere represents outputs and the ontological forms running down the central membrane of the two hemispheres represent engines of compilers, translators, converters and accumulators that exchange and transform inputs into outputs not only in one direction, but throughout the cells of the model set. In this embodiment, the entire model is a system, and the cells and constructs of the model set have the capacity to interact with each other. While this view is at the highest level, with cells and subcells and subsubcells etc. not visible, nor are layers beneath visible, nor are colors and patterns (fixed and in motion) or sounds or kinetics within the cells and models visible or sensorially available, if they were, one skilled in the art would discover how deep the meanings are that can be conveyed by the present invention of dynamic systemic semiotics as applied to proof and valuing and the representation of knowledge. In this embodiment of the present invention, a central dynamic cybersemiotic compiler converts standard inputs of information into semiotic formats using adaptive translation keys that can operate manually, semi-autonomously and autonomously, can operate as a self-learning system, and can readily adapt a key translation for an individual or group or circumstance into a personalized keyset, standardized for language according to the needs or preferences or cognitively adaptive mechanisms of the present invention. For example, if the general choice of the semiotic systemic is to use bright red to signify highly negative effects, a user or group of users could easily utilize the controls within the compiler keys to reset the construct to a different color throughout the model sets and usage. The cybersemiotic compiler, in one embodiment, converts source code to target and machine code, but it can also function in reverse, converting target code into source code. The cybersemiotic compiler, in one embodiment, also can translate any sensory input into generative source code such that the sensory object is stored, browsed and retrieved as relational data, linked via manual, semi-automated and automated processes and self-learning across every variable and cell affected by or possibly interactive with the new sensory input. And, in one embodiment, the sensory output not only is translated by the cybersemiotic systemic compiler into meaning, but the actual sensory instantiations become code, become meaning, become the dynamic interactive interface and become the environment containing systemic knowledge such as proof and valuing. One skilled in the art will recognize that the accumulator, a critical function of the cybersemiotic systemic compiler, builds accessible and adaptive ontological scaffoldings and arrays of dynamic interacting systemic knowledge that accumulate, moderate, summarize, link to every width and depth of granularity and perspective, store semiotically and via a robust scalable relational database, all history and documentation of any change, any proof, any valuing, such that anyone skilled in the art may readily experience such a view. The dynamic cybersemiotic compiler, in one embodiment, organizes and tags every variable according to standard or widely recognized data base protocols, but also organizes and tags every variable semiotically, with the patterns and cells originated by the present invention serving as the sensory tags and organizing schema. One skilled in the art could recognize that the semiotic systems, in one embodiment of the present invention, can operate in a totally semiotic environment, without the need for the reliance on language based tags, yet at any time, language based tags, words, numbers, charts and graphics and all forms of media can be accessed by the originators, mediators, users and contributors. Connective systems and networks in the present invention, in one embodiment, function as the mechanisms for input and the recipients of output, but the system itself, in one embodiment, functions as a connective system and network unto itself, enabling multiple users to interact with the semiospheres and model sets of the present invention. One skilled in the art may acknowledge that the present invention relies on the semiotic accumulation and compilation of common language and data into a multisensory cybersemiotic medium and language that in this embodiment can signify complex meaning associated with proof, proof processes, valuing and value exchanges, and all of the contextual systemic variables that enter into a whole and dynamic understanding of anything.

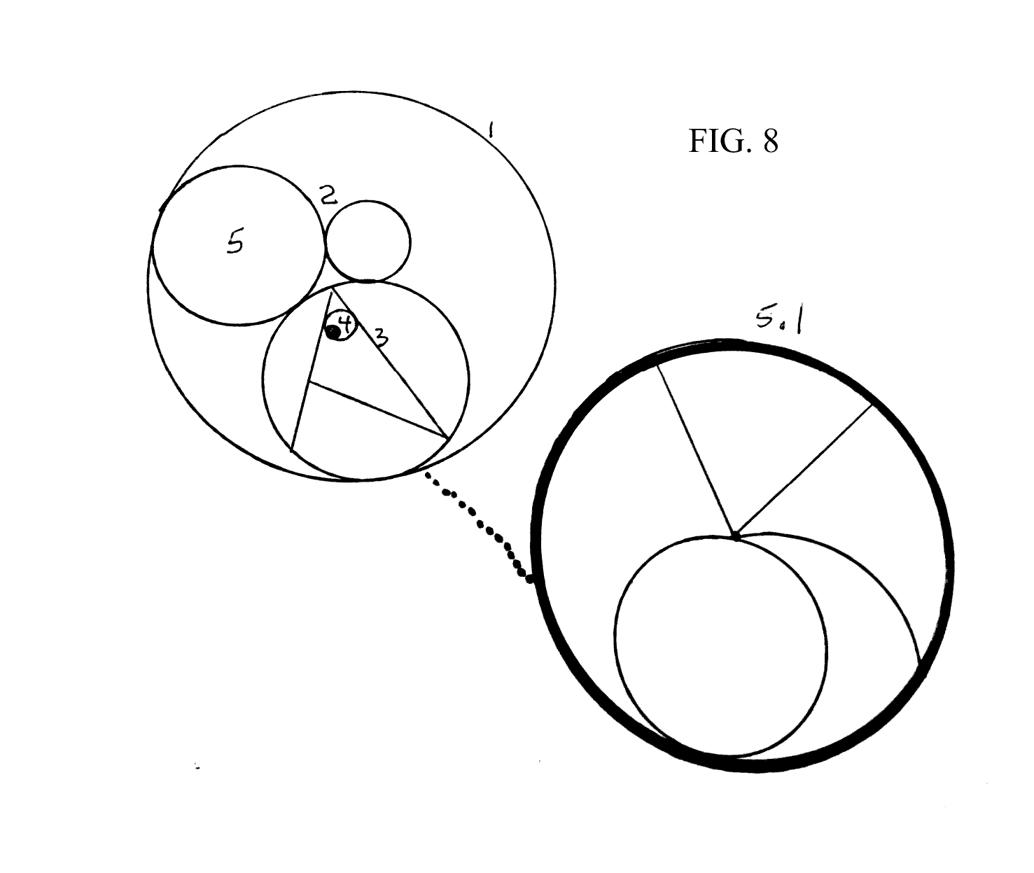

FIG. 8 Embodiments of the present invention include the application of multi-layered semiotic systemic dynamicontological model sets. FIG. 8 is an illustration of certain components and their relationships. A variable may be semiotically signified as a shape 1, functional as either a pixel or a cell, in this case as a cell. Within the cell may reside subcells such as the grouping 2 or cell 5, and within those cells, there may further be cells (subcells) such as 3 or 4, and within 4, for example there may further be pixels or cells, as indicated within subcell 4 by the present of a solid circle. Those skilled in the art may recognize that another layer or dimension may exist within and beneath the cells and subcells depicted in 1. A second layer, for example, or many more in further embodiments, may represent the solid circle in 4 with a fully developed subordinate cell set 5.1, for example, and so on.

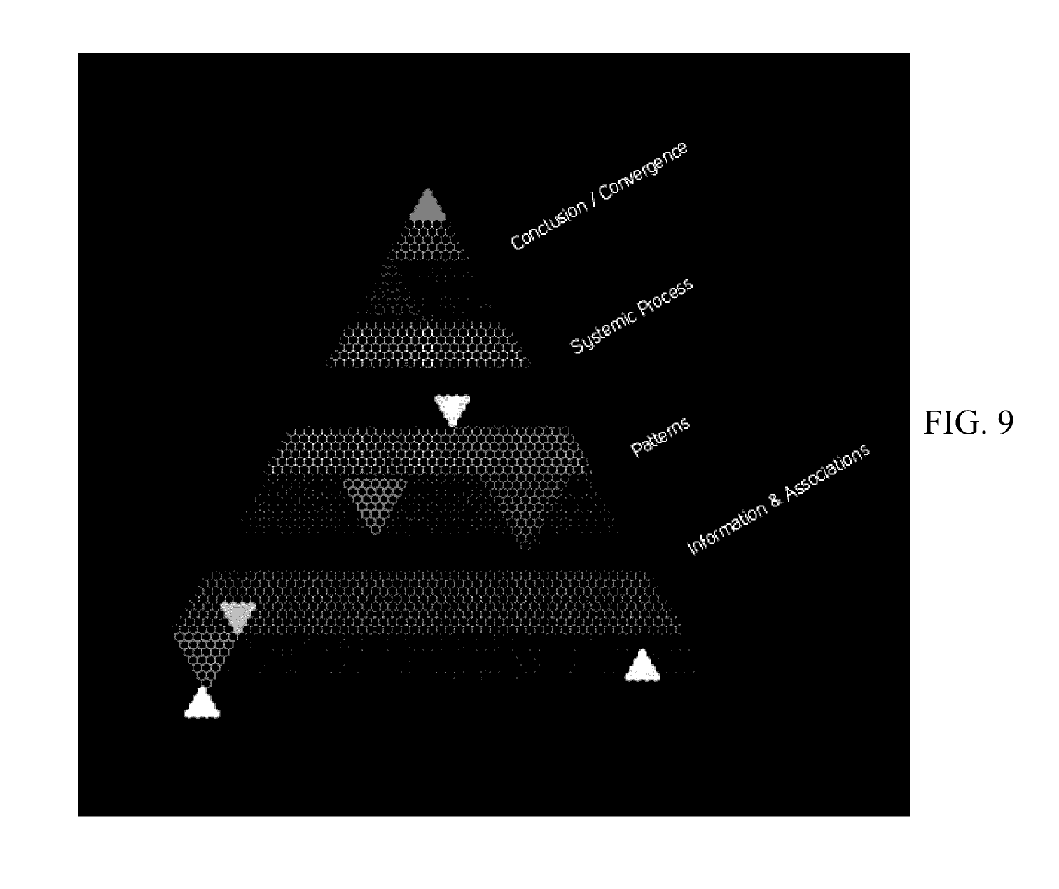

FIG. 9 Embodiments of the present invention may be illustrated with FIG. 9, one instantiation of a 2 dimensional proof model set consisting of pixels, cells, ontologies, color, pattern, segmented forms, a progression from base to tip, and layers of synthesis beginning with raw information and associations, compilation of raw information and associations into logic and science founded patterns, compilations of synthesis of the patterns into more fully formed systemic constructs and finally, at the top, culminations of conclusion and convergence.

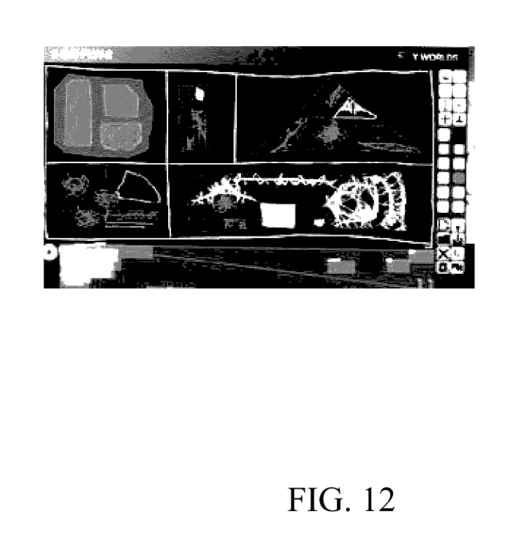

FIG. 12 consist of a screenshot of embodiments, among many, of the present invention, showing an instantiation of 2 or 3 dimensional controls, semiotic input toolsets, labels, and along the bottom, semiotic timeline histories of model set inputs and dynamic events along with documentation links for proofs and valuing.

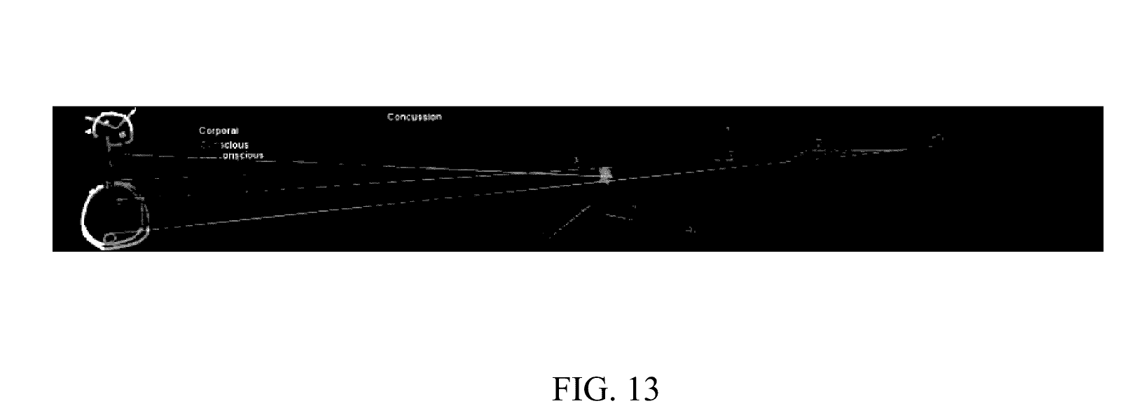

FIG. 13 consists of a screenshot showing detail of one simple embodiment of the creation and display of semiotic timeline histories of model set inputs and dynamic events along with documentation links for proof and valuing.

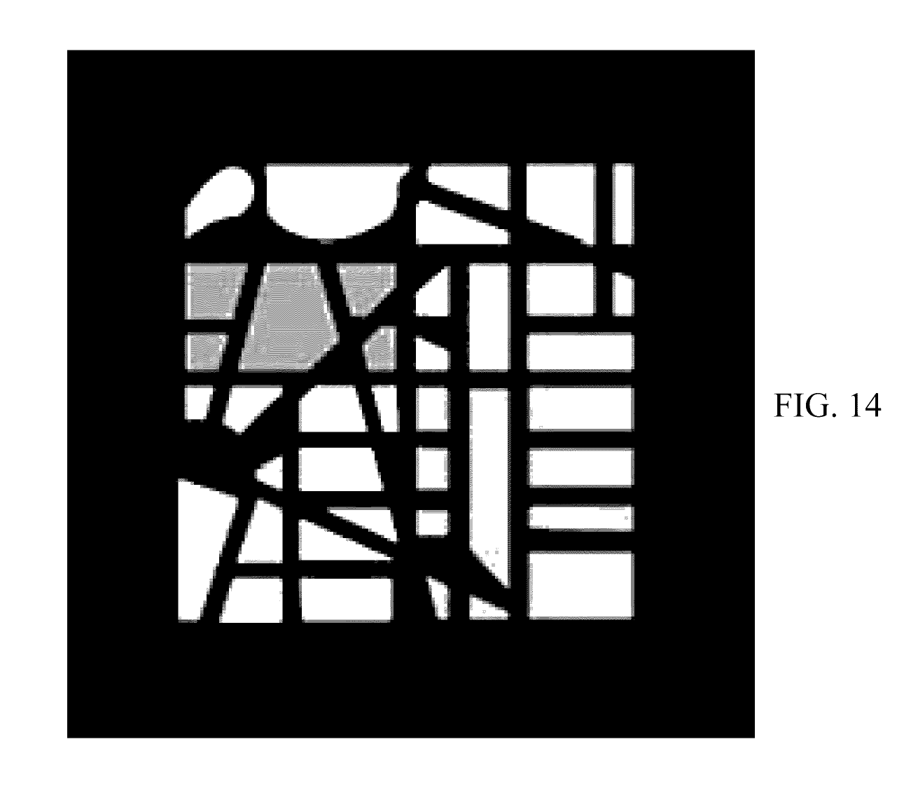

FIG. 14 is a screenshot illustrating one embodiment of a grouping of ontologies for proof or valuing by spatial position, shape and relationship at a high level view. This screenshot does not include any subcellular structures, layers, dimensions, colors, patterns, motion or multisensory characterization. This type of model set, since it has a distinctive use of shapes and forms, can become an easily recognized universal model set because of its unique visual and spatial composition.

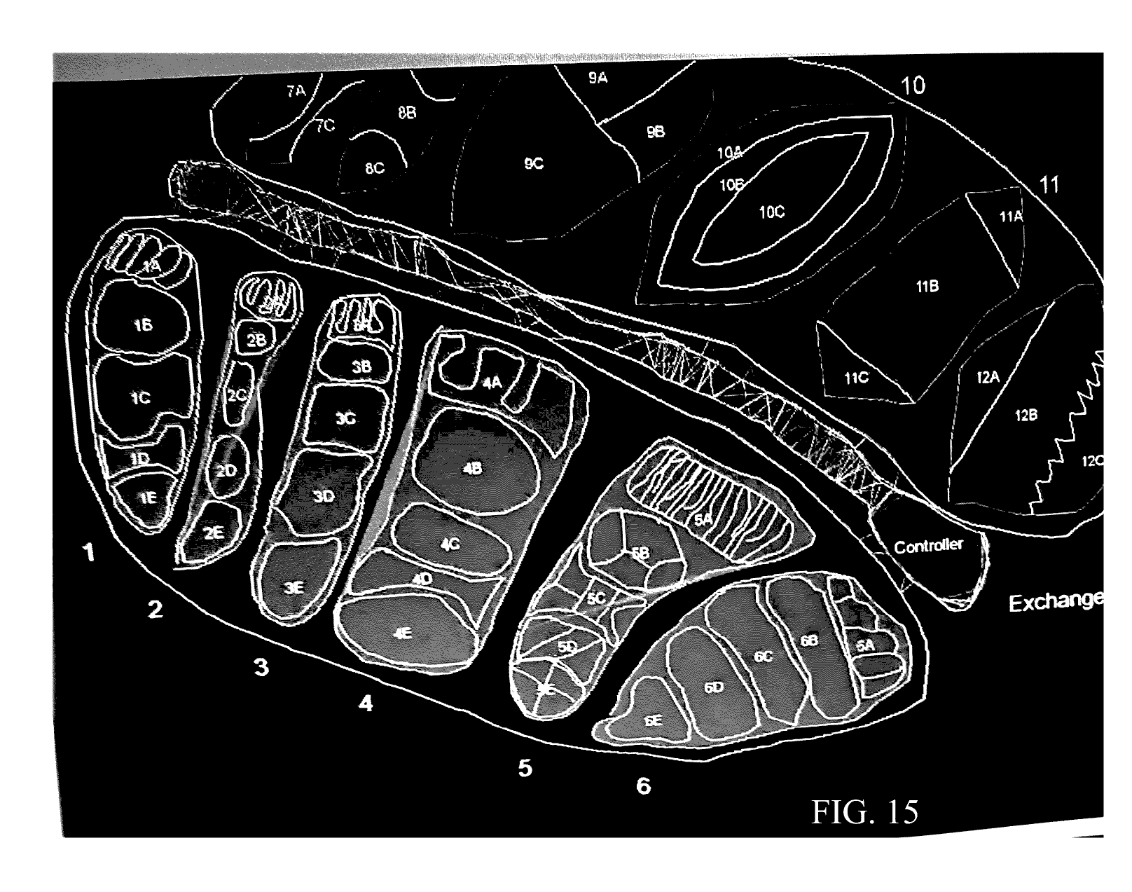

FIG. 15 is a screenshot illustrating one embodiment of a high level semiotic systemic grouping of variables within one or more ontologies. It depicts one instantiation of ontologically organized cells within cells using that would then be filled with pattern and color to convey standardized meaning.

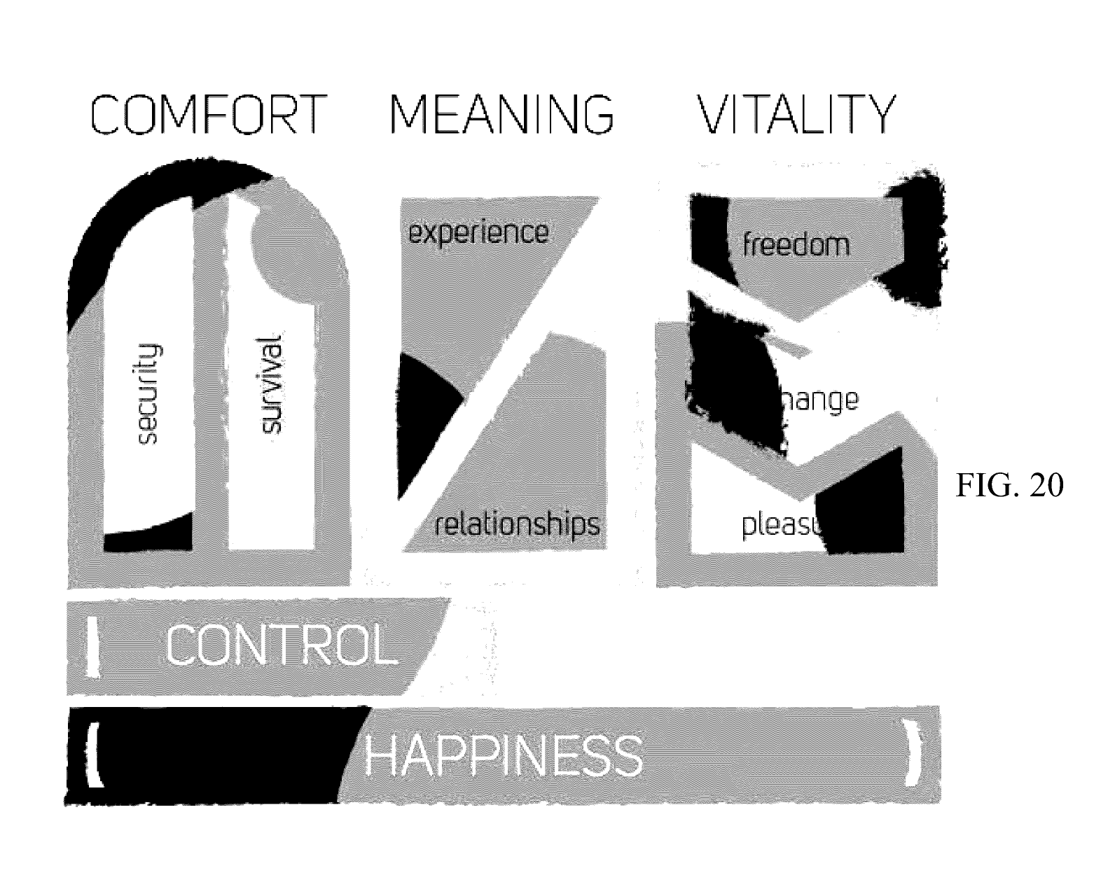

This screenshot does not include any subcellular structures, layers, dimensions, colors, patterns, motion or multisensory characterization. The numeric labels identify forms and membranes that would come to life and become filled with colors, patterns, multisensory forms and motion to represent systemic meaning within constructs such as proof and valuing, or elements of content or knowledge. FIG. 20 shows a limited instantiation of color and pattern.

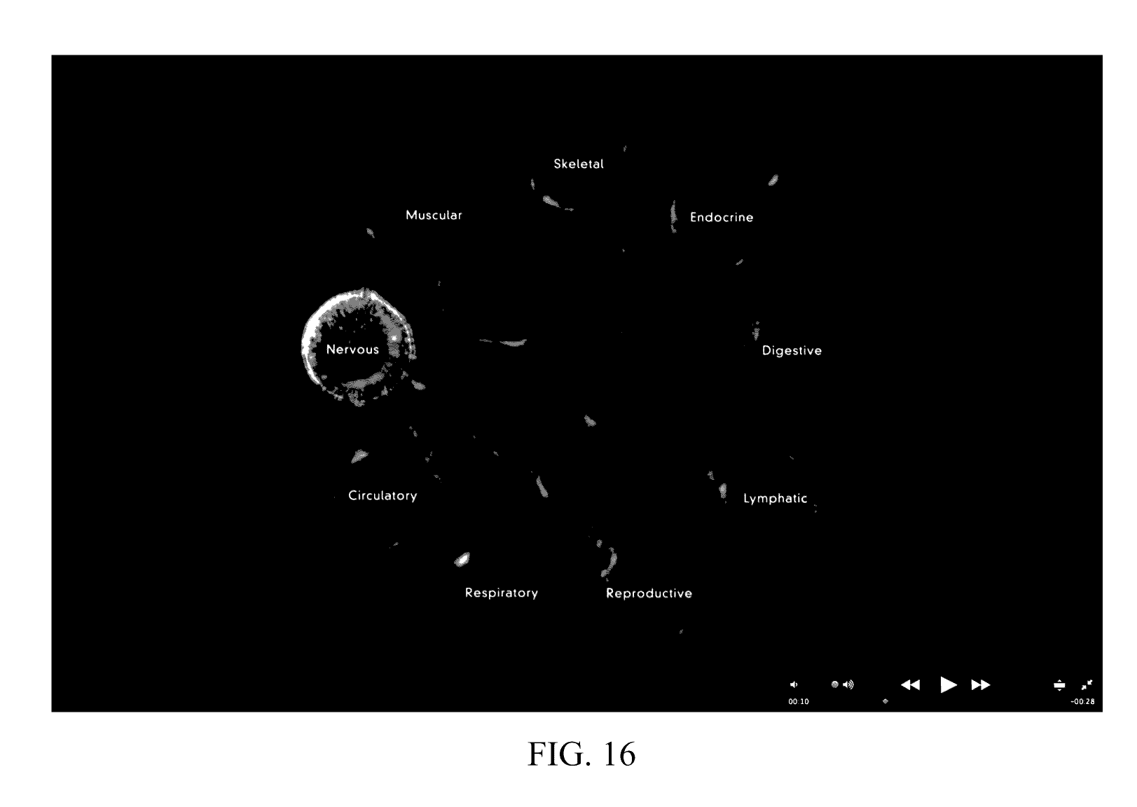

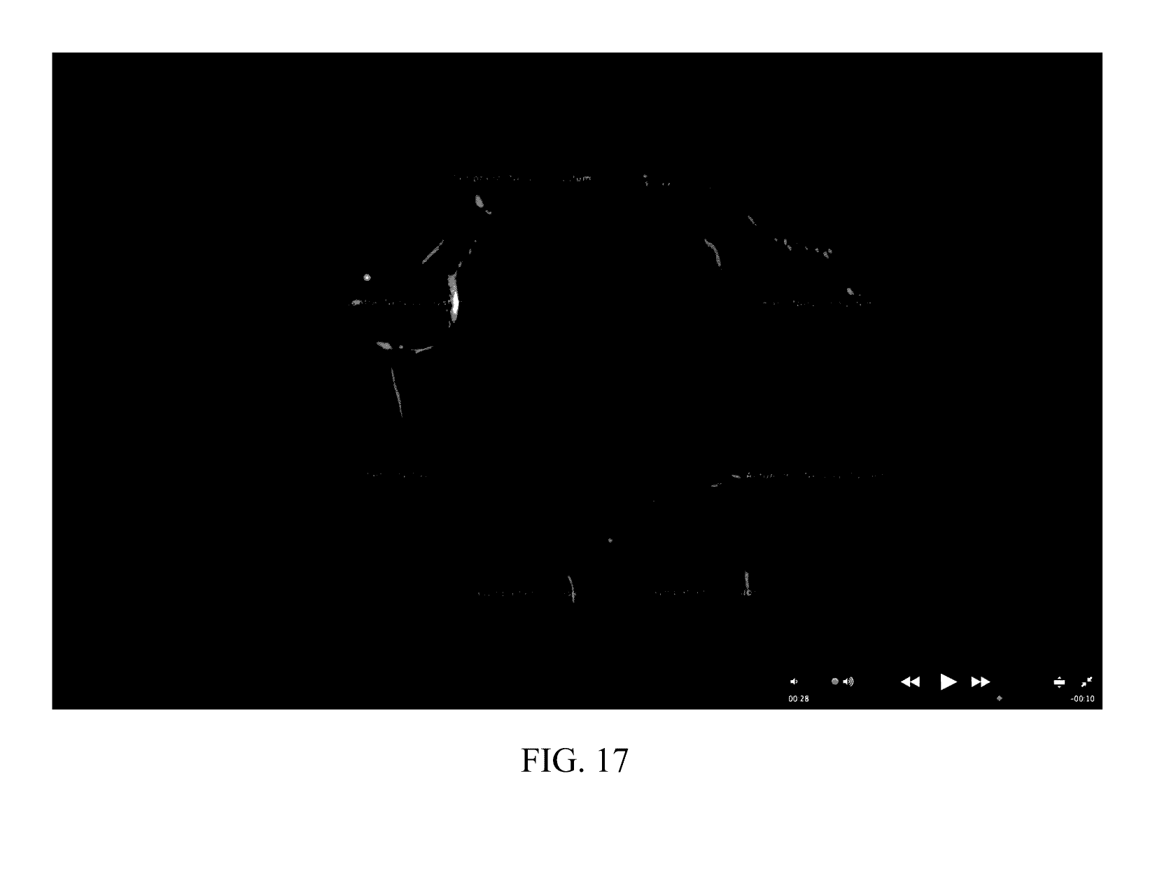

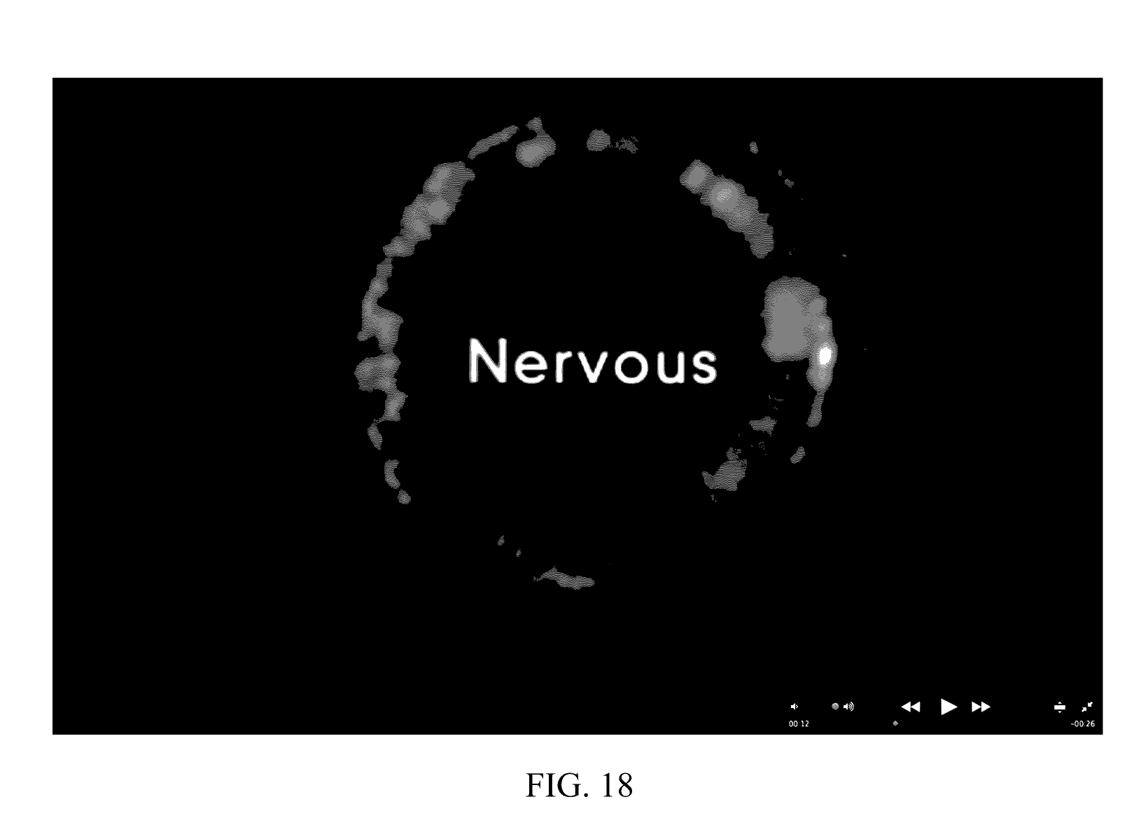

FIGS. 16, 17 and 18 are screenshots illustrating embodiments, among many, of the present invention. FIG. 16 is the highest level model set, while FIG. 17 is nested within FIG. 16 and FIG. 18 is nested within FIG. 17. These screenshots illustrate a dynamic semiotic form that, in this instantiation, represents systemic understandings of a portion of human functionality.

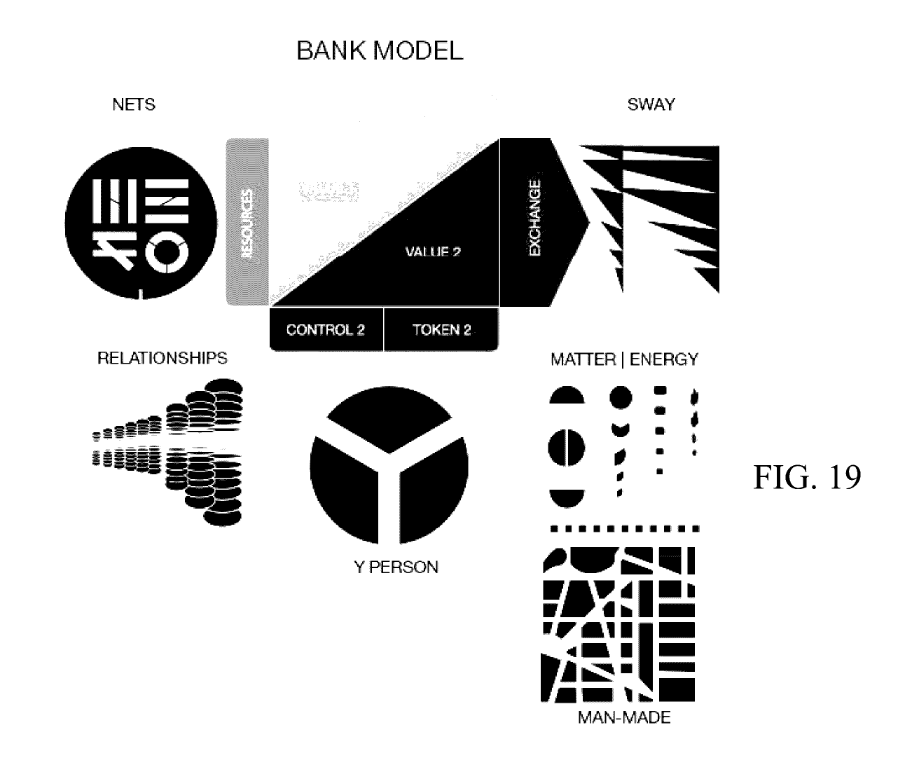

FIG. 19 is a screenshot of a high level semiotic valuing system of the present invention set within a systemic contextual semiosphere. The specific valuing model set, labeled “Bank Model”, is composed of the collective input of resources, a compiler that enables manual controls, semi-automated controls and automated controls to synthesize and convert resources and valuing into token sets that can be exchanged synchronously or asynchronously, stored or placed into a value added systemic model set. The semiosphere surrounding the Bank Model enables the semiotic communication of such external forces as power and influence, human desire, human needs, proofs, markets and more . . . .

FIG. 20 is an illustration of one embodiment of a valuing model set filled with high level cells and simple color and pattern. It is composed of constructs represented by the shapes, membranes, and forms of the high level ontologically grouped cells of the model.

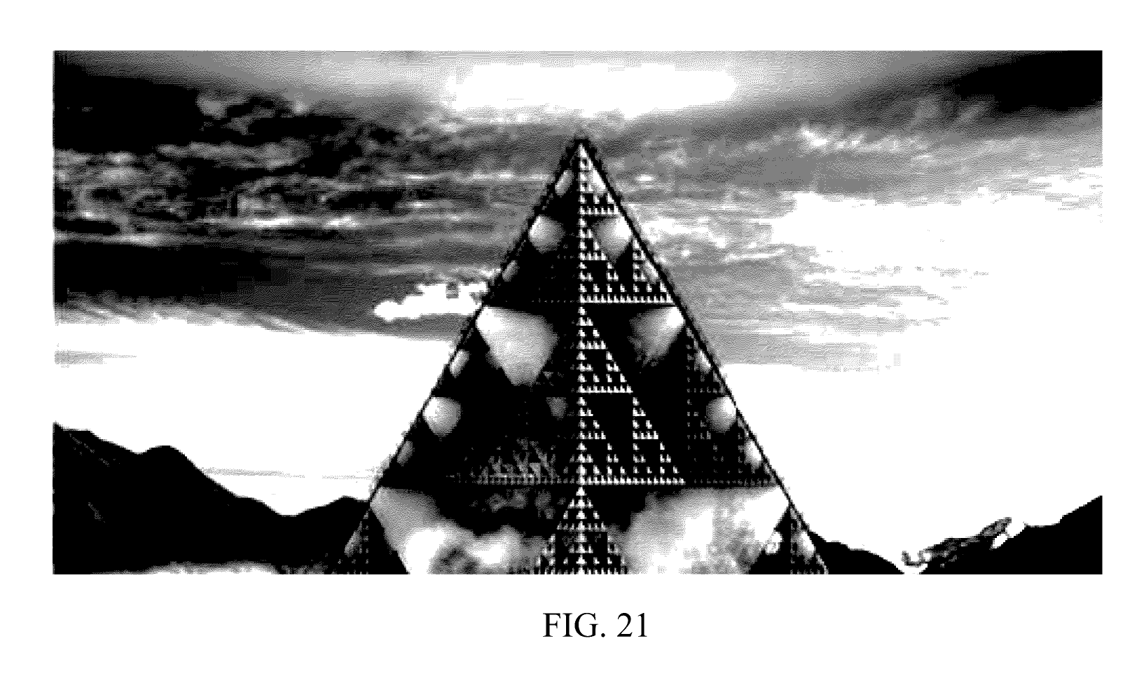

FIG. 21 is an illustration of one embodiment of a proof process model of the present invention, set within a portion of an interactive semiosphere that possesses the characteristics of a video game world.

From a user perspective, the Proof Process system of the present invention is composed, in one instantiation, of an application of multisensory art-forms, semiotic compilers, computer aided toolsets and personal/mobile computers and server driven networks which enable users to browse, navigate, search, obtain and contribute to comprehensive proofs and proof based valuing at any level of any component of human understanding optimized by their preferences and pattern recognition capacities, and by their desire to acquire their objectives in the fastest manner possible, delivering the meaning and content they desire in the most effective manner possible.

Humans have more and more information at our fingertips, yet much of this information remains untested, unverified and scattered across our consciousness. From human enterprise to scientific research, there are layers of interactions, scores of variables, systems and relationships existing across time and space. Words, presented linearly, cannot begin to convey the multitude of the simultaneously-occurring interactions that define our world. And words are limited by their single dimension, by barriers of literacy and geographic language, by the slant of definitions that vary from person to person, and by the language's inability to convey time and space and motion and relationship and change.

Humans understand by making connections and recognizing patterns. Visually, contextually, tacitly and auditorily conveying knowledge is more effective when developing and comprehending and communicating complexity.

In one instantiation, the Proof Process is ubiquitous—capable of being communicated from textbooks to the internet, from print publications to electronic databases and media, from human communications with paper and pencil to simple hand-signs and symbolic language shortcuts, from juries to decision-making, from voting to medicine, from law to science, from governing to leading, from guiding one's daily choices to guiding the choices of the world's largest organizations and more . . . .

There are many ways to implement the proof process described herein.

For the purposes of introducing some of the many creative variations of the proof process system, here is a single embodiment among virtually unlimited variations:

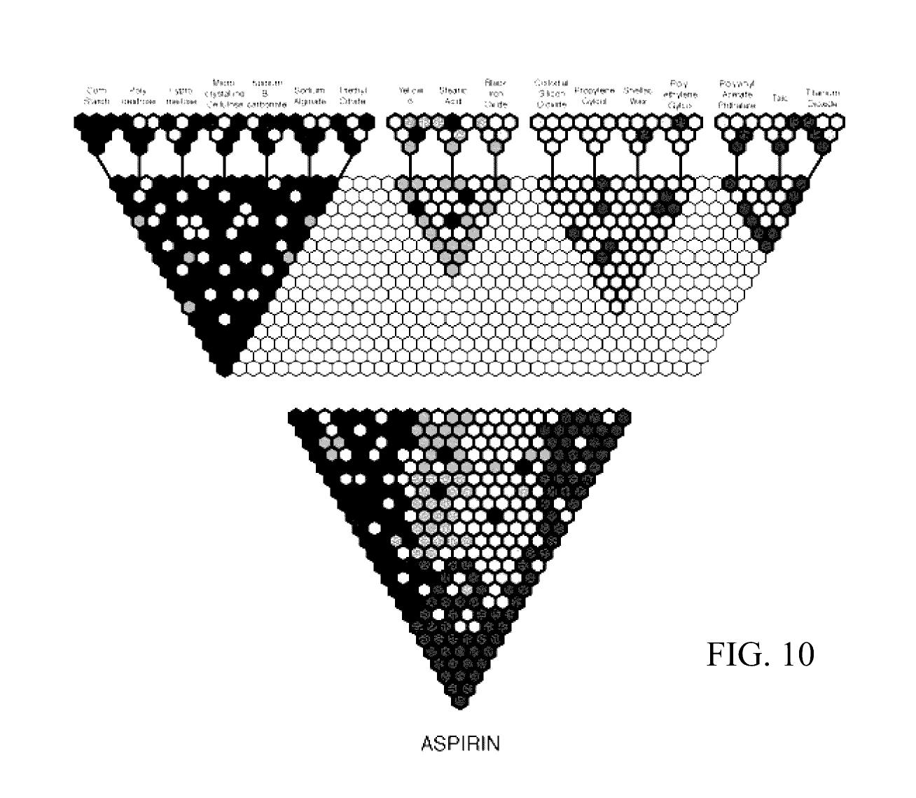

In one embodiment of the Proof Process, illustrated by FIG. 10, the use of color, pattern, form, geometry, environment, texture and other variables of visual perception are optimized by research and self learning for use with the general public or with a specific individual or class of individuals. However, every individual can participate in a sequence of visual on screen tests and measures that optimize the systemic visuals but not necessarily the meaning of the visuals. For example, the use of the color red can be optimized according to the global norms of perception or adjusted on the computer specifically for the individual user on the basis of any relevant visual perception variable such as but not limited to culture, hue, chroma, value (lightness), line form, pixel form etc. Similarly, the use of semiotic audio can be optimized for human perception on a global norms basis and can also derive through computer based testing an individual user's perceptual science based upon but not limited to such variables as culture, tone, loudness, rhythm, pitch, timbre, harmonics, progression, decay, timing, correlation to visual and more. Similarly, tactile and kinetic semiotic communications can also be optimized for culture or individual preference or cognition according to but not limited to such variables as body location, intensity, pattern, motion and integration with other sensory mechanisms.

In one embodiment among many, there can be 5 colors: 2 negatives consisting of a bright red (−− most negative) and a light red/pink (− less negative), a neutral/uncertain grey or dark brown, and 2 positives consisting of a bold bright blue (++ most positive) and a light blue (+ less positive). White or background colors may indicate missing or no information.

Each colored pixel in the proof process model may, in one instantiation, represent the point of a detailed proof process “pyramid” that exist perpendicular and beneath the plane of the model, culminating at the point with the summary color pixel that is exposed in the model. When any color is viewed, it may mean, in one instantiation, there is a point of knowledge reported as part of the systemic collection of all available knowledge to be interpreted according to the rules and language that define the meaning of color and pattern and any other variables . . . .

Every bright red pixel, for example, may indicate validated evidence, documented by lower level proof pyramids, that the variable is highly likely to cause significant harm. A light blue pixel, for example, can indicate validated evidence from lower level proof pyramids that the variable initiates positive exchanges in the body that outweigh evidence of harm.

If there is conflicting data, they can be represented in one instantiation by multiple color pixels representing the tip of each derived proof process point of information so that the user can perceive the mix of research and evidence. In one embodiment, every proof process array is constructed from raw first principles empirical, experiential, observational, scientific evidence at the base, moving toward processing and synthesis and systemic constructions in the middle and finally toward consilience and conclusions near the peak.

A Proof Process array in one instantiation may have beneath it a pixel by pixel documentation and detail Proof Process array and every Proof Process array may have a corresponding validation pixel model that portrays all pixels according to their replicated scientific validation (using two green colors (bright rich green for most valid, and a soft green for less valid+) and two yellow colors (a rich bright yellow for extremely invalid−—and a soft yellow for invalid−. Their validation from people with knowledge to contribute on the topic, and the curated representation of all necessary points of derivation according to whether there is or is not ample evidence to support verification. Proof Processes can also be constructed according to viewpoints and perspectives, according to hypothesis, and according to various forms of alternative Proof Processes.

In one embodiment, 2, 3 or 4 dimensional triangles are constructs that represent from a curated viewpoint all of the necessary points of validation to support knowledge at a level of detail in the model. So, for a specific ingredient such as propylene glycol, one would want to know such things as longitudinal studies isolating this particular chemical in terms of biological interactions and chemical interactions, one would want to know experiential reports of impacts, one would want to follow the chemical throughout the body with many systemic measures, one would want to know the necessity of the chemical as an ingredient, one would want to know of simulations and similar compositions and their health results, one would want to know if the ingredient contains trace elements of other ingredients, one would want to know how the ingredient affects the environment that then affects humans, one would want to know if the ingredient is safe to ingest, breath in, absorb etc., at what amounts, one would want to know if the chemical breaks down and changes into other compositions over time or through interaction, one would want to know if the human body has ever had the opportunity to experience the chemical to the degree it has pre-existing programming to safely interact with it, one would want to know if it is safe for fetuses or people with certain predispositions, etc., etc., etc. repeated for every product humans interact with. This involves a lot of data points, shaped into systemic knowledge, and ultimately, a conclusion.

In one embodiment, illustrated by FIG. 10, the triangular proofs closest to the base of the larger model set triangle may represent first order, first level, data collection and evaluation. Each pixel color may represent contributing points of information as judged by curators with a transparent documentation sub Proof Process showing the derivation. The second group of connected triangles may represent ontologically grouped variables evolving from the first set of triangles, and attempts to identify evidence that the components of that grouping do or do not cause harm, do or do not benefit the body. This is a synthesis phase, attempting to move beyond individual components of input and information into ontological constructs that group the variables according to certain features that appear to drive the systemic analysis of good and bad.

The large triangle at the peak of the model attempts to represent whether taking the specific aspirin portrayed in the model is or is not the one a person with full knowledge would want to choose. One can compare this culminating Proof Process triangle with those of other aspirins to determine what pills are most likely to be of maximum benefit or most likely to cause the greatest harm. If the portrait of the aspirin contained only starch and the active aspirin ingredient, there would be very little red in the final triangle, with the red linked to damage to children and to the digestive system of some people. Remember, these models are dynamic and interactive—click on any pixel and you can view the complete derivation proof process beneath with all associated research and citations.

The systemic of the present invention will in certain instantiations utilize self-learning or pre-programmed agents, algorithms or agencies to self-organize and group like colored pixels to allow the user to instantly process the degree of red and blue and make an instant judgment of the degree of color domination. Mixing all the colors spatially is less useful. Note that all the categories of the pixels have not been labeled for this example.

Embodiments of the present invention include multiple dimensions and layers. FIG. 11 illustrates how multiple proof model sets can be organized spatially to represent systemic connectivity. In this instantiation, proof 1 connects to proof 2 within one plane, and proof 1 also connects at the tip to a single pixel (cell) of proof 3, whereby the color and pattern of proof 1 at its top cell (pixel) becomes the cell (pixel—complete with color and pattern) of proof 3 at spatial location 4.

In one embodiment of the present invention, the proof process system enables the robust selection of angles and perspective views, layers, dimensions, model sets, zooms, drill down, multiple windows of comparison and overlay, high level map location finders, wysiwyg controls, omnipresent controls, semi-transparent controls, touch controls, touch input, touch output etc.

The objective of the Proof Process, in one embodiment, is to establish the language, form, process engines and toolsets for anyone seeking to prove something, validate something, understand something, take puzzle pieces and put them together, apply logic and reason, apply deduction and induction and imagination, hypothesize, produce algorithms and mathematical relationships, create vectors of linkage, create scaffoldings up toward conclusions and culminations, map and compare what “is” to a law, rule, hypothesis or standard or create scaffoldings to display the systems at work, create scaffoldings to apply a conclusion and validated components of knowledge to a problem or situation.

In one embodiment, a proof process model set at every level is composed of a triangle (or pyramid—or any other specified shape) filled with triangles filled with honeycomb points of data. The triangles all have defined areas (fields) within them that contain levels and dimensions of a proof or sub proof. The operating honeycombs within a triangle may be filled with validated points of data or representations of the range of research and data available. Such triangles, in this embodiment, can be interlinked to show deduction (bottom up) or induction (top down). A proof triangle (a) can attach at its point to the point of a related proof triangle (b). Or, in one embodiment, five proof triangles can connect and link semiotically to the base of one large triangle representing the next level of processing.

In one embodiment, a deductive proof process model set may progressively assemble from base to peak, and dimensionally behind and around it, the information and associations, the determination of all relevant variables and relationships, the formation of patterns of connection/exchange/relationships (science, logic, reason, systemic ontological organization etc.) among the variables, the increasing consilience toward the desired objective, the characterization of what needs further evidence and what possesses substantial evidence, the characterization of understandings of systemic dynamics in terms of validation and context and perspective, and the degree of convergence toward the objective.

Proof Processes may in one instantiation adapt to specific objectives. If one were to prove that the earth is round, one can convey within the proof process semiotic model sets the images and measurements that reference the definition of round and the actual measures of the earth taken from multiple validated sources. The earth actually is not round in the pure sense.

For guilt or innocence in a court, there are the legal constructs that have to be recognized, and the Proof Process may align with the legal definitions—including evidence and validity of sources and human motives.

The Proof Process may revolve not around the polarity of plaintiff and defendant, but around a transparent visible organization of the variables and evidence and connective tissue that is applied against the systemic objective—which in this case involves a law or laws and rules of evidence and guilt/innocence that must be confirmed to have case merit.

The Proof Process for the “cause” of a disease may include model sets such as the workings of the body, the genetics and programming, the interactions with the environment, the interactions with constructs such as stress and happiness, the nano to macro matter: energy perspectives, chance, long term controlled correlational data, observation etc.

To definitively identify the “cause” of a disease, one can pre-build and populate semiotic model sets with everything one would need to know in order to reach a definitive comprehensive conclusion—or to rule out certain hypothesis and variables.

Higher level proof processes of the present invention may rely less on specific words, and more on cognitive semiotic constructions made transparent through semiotic form, color and pattern coded mechanisms that function as the consilience of lower level proof process instantiations.

The dynamic cybersemiotic proof process of the present invention includes but is not limited to the constructs of valuing and value exchange. Meaning is encoded through semiotic compilers and multisensory semiotic schema

When a jury or jury like group receives material input, is supplied with the rules for judgment, if any, and then participates in a process of synthesis, deliberation and judgment, they typically lack a toolset, a process, a mechanism of organization, composition and review, that enables them to construct systemic knowledge sets that allow them to experience through visualization and semiotics the conclusive peak or peaks of consilience and divergence that together frame whether there is binding evidence for a conviction and a highly validated judgment, or insufficient information and non trustworthy source content that leads them to negative conclusions and doubt, while identifying all that is necessary to reach a definitive positive or negative or explanative conclusion.

Proof processes, in one embodiment, can be dynamic, interactive gaming-like worlds capable of robustness and scale that can adaptively resolve any user's objectives and requirements. The present invention may also show the sourcing and documentation of every component, the critical mass of validations, and include diverging facts and viewpoints, alternative derivations and conclusions, and a complete spectrum of layers from nano to macro, from narrow to wide, from self to other perspectives.

An embodiment of the present invention is illustrated in FIG. 10. FIG. 10 shows a single instantiation that identifies the systemic variables that determine what we put into and onto our bodies and must be signified in a proof process in order to be accurate, understood and comprehensive.

A comprehensive proof process, in one embodiment, may assess each person's body specifically, track the quantity of the product ingested or absorbed, identify accurately all ingredients—the processes, mechanisms and secondary resources used to produce the ingredients, the availability of alternatives and the judgment across a spectrum of multivariate factors as to whether any ingredient, or any mix of ingredients within the product or associated with application, has the relative or absolute probability to cause harm.

A proof process may be conducted, in one embodiment, using an interactive dynamic semiotic communication system configured to conduct a comprehensive proof. In one embodiment, the proof system may be configured such that it semiotically compiles and organizes data, knowledge and belief into visual compositions that at the highest levels signify the high level variables and constructs according to a multidimensional progression from facts and details to the organization of that foundational information to the synthesis of that information to the mapping of reasoning scaffolds to consilience and conclusions.

The semiotic communication system for proof process and valuing may also be configured such that it has an initial pyramidal ontological dynamic patterned framework that enables semiotic forms of knowledge reasoning and progression toward proof objectives—consisting of evidence and observation, systemic foundations relevant to the evidence, convergent and divergent reasoning, logic arrays, deduction/induction/abduction, alternative pathways and hypothesis, knowledge processing and synthesis, knowledge trees and groupings, critical or missing elements, a checklist of the variables and compositions of a perfect proof, validation and verification, sourcing and documentation, metrics relating to the objective, relationships among the variables, time and space mapping, and the complete history of edit and change with links to all relevant resources, sources, multimedia material, and archival material.

The semiotic communication system may also have a relational data base and semiotic compiler constructed through a dynamic interactive semiotic pattern interface that automatically codes, tags and characterizes all relevant or essential variables and all relationships and states among the variables, including an unlimited family of perspectives, dimensions and characterizations, in such a way that all knowledge at the highest levels can be organized, modified, stored, searched, browsed and retrieved via an interface composed of representational multisensory content and powerful intuitive soft and hard controls.

The semiotic communication system for proof and valuing may also deploy a visual semiotic assembly of information and associations, the determination of all relevant variables and relationships, the formation of patterns of connection/exchange/relationships (science, logic, reason, systemic ontological organization etc.) among the variables, the increasing consilience toward the desired objective, the characterization of what needs further evidence and what possesses substantial evidence, the characterization of understandings of systemic dynamics in terms of validation and context and perspective, and the degree of convergence toward the objective. The self learning software of the present invention may, in one embodiment, flag or identify what is missing in a proof, identify behind the semiotic surface statistical features, statistical correlations, and standard deviations between and among variables, probabilities, and projections.

The semiotic communication system of the present invention may also have a multi-dimensional robust dynamic cybersemiotic architecture consisting of scaffolding, lattice, and ontological cellular maps.

The semiotic communication system of the present invention may in one embodiment be composed of a generative bio/physio-mechanical semiotic compiler and architecture whereby the generation by the present invention's toolset of a cellular bounded line becomes the code, the image, the storage, the retrieval, the history, the time and space representation and the meaning. The line, in this instantiation, becomes a form of pattern based communication through the semiotic compiler which drives ontologically and semiotically transformational software translation, language translation, and systemic meaning representation.

The semiotic communication system of the present invention may be composed of coded auto generative software compilers and self-learning systems that self organize, self replicate, self direct, self code, self connect and self actuate based upon semiotic touch or voice or motion programming or any form of digital or analog input. The semiotic forms and patterns in one instantiation may behave in accordance with living systems, matched with human cognition and with brain function so that they represent and signify characteristics of life forms and non-living systems.

In one embodiment the present invention may consist of a dynamic cyber-semiotic self-organizing information system.

In one embodiment the present invention may utilize auto-grouping and self-configuration to orient cells and variables within models and to orient the patterns within the cells and the forms that define the boundaries of the cells.

In one embodiment, the present invention utilizes a unique video game-like interface, controls and navigation such that all variables visible or audible, and all variables existing within a semiosphere, may be searched, browsed, manipulated, accessed and filtered according to user objective, the systemic relationships among the variables, cause and effect associations, properties, levels of meaning and perspective and other constructs necessary for understanding.

In one embodiment, the present invention functions as a systemic cyber-semiotic compiler, interpreter and translator. The present invention, in one instantiation, consists of a high level computer language set that produces relational databases, generative and code driven multimedia, manual and autonomous toolsets, processes, controls and screen interfaces and displays that enable a user or those skilled in the art to produce a high level dynamic cyber-semiotic language that becomes the seminal compiler/translator/interpreter upward for the original source languages and downward for the target programs/object code/machine language.

The present invention's cyber-semiotic compiler code sets, in one instantiation, can become a multimedia language accessible by touch, drawing, macro command, controller, keyboard, mound, voice command, motion command, tactile input, import and text on screen, and function not only as an upward and downward compiler but also semiotically represent and signify any level of meaning and knowledge via human cognition of color, pattern, shape, sound, touch, motion, kinetics and interaction/change and the keys associated with compiled or cognitive/sensory translation.

One instantiation of the dynamic cyber-semiotic self-learning compiler organizes complex systemic knowledge and translates information, data, knowledge, research, theories, group inputs, algorithms, schematics and drawings, observations and media into a dynamic semiotic portal that represents meaning and perspective through sensory patterns designed to communicate and control all systemic inputs and outputs via fixed and living ontological maps and models and scaffoldings and multi-dimensional matrixes that house the interpretations using a unique disclosed keyed mechanism of visual, auditory, and touch/kinetic forms, patterns, motions, spatial position, ontological association and characteristics.

Embodiments of the claimed invention uses the dynamic cyber-semiotic compiler to characterize and utilize motion, energy, sensory properties, spatial location, and relationships among variables, inherent and new programming, time, state, history, validation, transformation and prediction.

The dynamic cyber-semiotic manifestations and mechanisms of the present invention include but are not limited to the following:
2D, 3D, 4D, virtual reality systems, mixed reality systems, tactile and GPS systems
mechano biological “living” semiotic forms
mechano physical “living” semiotic forms
pressure/tension/architecutures/struts/matrix/lattice/cytoskeleton/firmaments spatial organization & relationships across time
dynamos/flows/exchanges/states/transitions/transformations
glues/correlations/bonds/activation/actuators/proteins/transducers/switches
a cyber-human autopoietic system capable of reproducing and maintaining itself (self producing, self maintaining, self repairing, information repository, & processing)
code that produces media, media that produces code, media that produces meaning, media that becomes high level code
a dynamic cybersemiotic compiler whereby media becomes meaning/meaning becomes media and pattern & form in context directly become semiotic meaning
visual worlds called semiospheres that contain objectives driven navigation & controls based upon semiotic ontological maps & models representing knowledge & meaning, objectives and content
dynamic interactive robust scalable self-configuring living nodal-cellular object & pattern representations
virtual semiotic languages composed in part of generative relational code whereby the code at the highest level becomes visual for input:entry:storage:retrieval:navigation:browse & search:output
self-organizing and semi-autonomous maps & models

In one embodiment, a system of proof may include the following ontological characterizations, realized through physical manifestations of designed patterns of visual, auditory and touch forms. These characterizations may be presented to a user of the system of proof individually, or in one or more subcombinations. The combinations and subcombinations of the list below, and others, may be selected by a user of the system of proof or they may be preselected based on an identified objective of the user.

Points of Knowledge (Information)
Systemic Knowledge
Motion Knowledge
Relationship Knowledge
Past Knowledge
Creations of New Knowledge and Insight
Future Predictions/Projections
Perspectives
Hypothesis
Strategies
Consistency with Laws, Requirements, Standards, Baselines
Cause-Effect
Human Mysteries & Problem Solving (Trials, Responsibilities,
Intent, Causation, Mechanisms & Processes etc.)
Science Based Mysteries & Problem Solving
Browse the Relative and Systemic Proofs and Proof Status for Any and All
Information, Data and Knowledge
Deconstruct/Evaluate Anything According to a Proof Process
Instantly Recognize the Meaning Portrayed By a Complete Proof
Collect & Connect and Communication All Relevant Variables for a Proof
Prove the N of Variables & Define all Variables Associated With a Proof
Scaffold Structures & Various Semiotic Constructions
Perspectives, Logic, Reason, Evidence
Accumulation (research, extraction, documentation, sources,
evidence, missing, gaps,)
Synthesis of Variables & Stages of Proof
Processing Stages & Forms
Pattern Generation
Convergence/Divergence
Validations/Invalidations
Consilience
Alternatives Viewing
Timelines and Spatial Tracking
Modifications & Edits Tracking

In one embodiment of the present invention, the spatial placement of semiotic ontological cells and cell groups within the proof process may comprise a series of layers, for example a surface or highest level layer of cells, and/or the creation of subcells within the cells, and subsubcells within the subcells etc., all within the scaffoldings of proof, such as triangular shapes, allows the representation of progressions of thought and synthesis, of logic and reason, of cause and effect, of facts and validations from detail to conclusion.

In one embodiment, the use of color, pattern, shape, motion, visual context, structured semiotic environments, kinetics, and sound to characterize meaning are all possible within the proof process system and the subordinate valuing systems, either alone or in combination.

Some exemplary embodiments of the Proof Process and Valuing Systems include, but are not limited to:
1) A relational data base and semiotic compiler constructed through a dynamic interactive semiotic pattern interface that manually and/or automatically codes and characterizes all relevant or essential variables and all relationships and states among the variables, including a family of perspectives, dimensions and characterizations, in such a way that all knowledge at the highest levels can be organized, modified, stored, searched, browsed and retrieved via a visual interface composed of representational visual content and powerful intuitive soft and hard controls.
The interface can take any visual form, but the semiotic process of the present invention includes, but is not limited to, particular defined and interactively designed meaningful uses of shape, color, texture, spatial position, creative arts, pattern, contextual environments, sound, motion, kinetics, ontological model membership, sound, dimension, time sequence and time line, propagation, relationship and input/output. In one instantiation drawing on the screen of a computing or communications device using wysiwyg touch, draw, toolsets or generative propagation automatically creates real time relational generative code via a semiotic compiler that can then translate, reproduce, store and retrieve, display and record the visual identity of the sequence and features along with every other sequence and feature within the bounds of the derived dynamic semiotic knowledge world being created.
2) An interactive objectives driven portal that enables and empowers the user to examine and extract any component of any proof at any level of detail, any dimension, any perspective.
3) A semiotic systemic that organizes the Proof Process as a visual narrowing (deduction) or expansion (induction) (using geometric or landscape or artistic forms that have a large base and a narrow peak) beginning with either a large base of raw data or a peak denoting a beginning objective or an ending conclusion.
4) A semiotic system whereby the Proof Process form contains ontological pixels, arrays and cells representing data points and variables. Perpendicular to each cell is a substantiating Proof Process defining the source of the data point and all information relevant to the extraction and derivation of the data point.
5) A semiotic system whereby the Proof Process uses a simple set of colors to identify scales including but not limited to positive and negative, active or inactive, valid or invalid, primary or secondary, cause or effect, unilateral or multivariate.
6) A pyramidal ontological dynamic patterned framework containing forms of knowledge reasoning and progression toward proof objectives—consisting of evidence and observation, systemic foundations relevant to the evidence, convergent and divergent reasoning, logic arrays, deduction/induction/abduction, alternative pathways and hypothesis, knowledge processing and synthesis, knowledge trees and groupings, critical or missing elements, a checklist of the variables and compositions of a perfectly complete proof, validation and verification, sourcing and documentation, metrics relating to the objective, relationships among the variables, time and space mapping, and the complete history of edit and change with links to all relevant resources, sources, multimedia material, and archival material.
7) A software toolset that enables and empowers originators and users to create, craft or modify existing proof process sets with simple touches, clicks, control toolsets or voice commands of cells, pattern and art generators and objects—with every input captured as recallable historic record in a form consistent with real time generative relational code or in other instantiations hard stored image files.
8) A semiotic control system whereby any component and model within any proof process is robust, scalable, malleable, and mobile, with the user able to move, zoom, dynamically view timelines, group models, run dynamic sequences etc.
9) A cybersemiotic compiler optimized for real time speed, robustness, and realization operations applied to the intent of the user, the maximization of processing and bandwidth resources, image generation processes, algorithms, auto and manual linkaged among datasets, image-sets, and controls.
10) A cybersemiotic deeply coded compiler that can produce, but is not limited to, the following features:
generative visual, auditory, and tactile outputs
virtual reality and mixed reality, 3D
autopoietic visual, auditory, and tactile outputs
generative visual, auditory, and tactile inputs
autopoietic visual, auditory, and tactile inputs
semiotic self programming & self organizing
semiotic object time tags, source tags, categorization tags—filter controls
semiotic patterns & progressions
semiotic storage & search
a comprehensive selection of views, perspectives & on screen content
a comprehensive selection of objectives & filters
semiotic models organized by objective/meaning
pre-built modifiable reference models
a system whereby external knowledge may be located, extracted or selected and automatically or manually loaded into dynamic semiotic models with all variables connecting to that new information also manually or automatically loaded into the semiotic depictions and propagations
11) Controls—For all computing and communications devices with human interfaces for text, keyboard, touch, audio or kinetic capability, the present invention uniquely focuses on objectives and meaning as defined by the originators and users, relying on intelligent systemic semiotic controls that enable the user/originator to accomplish their objective according to the level and expression of meaning that they desire or require. The control ontologies on screen may include controls that deploy, mobilize, hide or make visible all forms of control. The semiotic compiler may in one configuration automatically drive the use of a specific color through pre-determined algorithms identifying when certain colors, color intensities, cell and ontology configurations, line widths, patterns, shapes and kinetic movements, for example, are to be activated and applied. The present invention utilizes a full range of possible controls, including but not limited to “what you see is what you get” (wyswyg) linear and multi-dimensional sliders, overlays, map layers, animations and draw functions and features etc.
12) The present dynamic semiotic invention, in certain embodiment, portrays meaning, relationships, sequence and time stamps, cause and effect, active, inactive, data, sources, validations, valuing, variables, ontological schemas, cellular dimensions, scales, objectives identification and satisfaction, characterization, translation, search, input, browse, print, hive participation, hive organization, world building at every level and dimension, spatial location, exchange depiction, change and state depictions
13) The semiotic (audio, visual, kinetic) patterns and forms and movements and symphonic multivariate depictions are designed, compiler and source coded and implemented in such a way as to function as:
   a) a universal systemic semiotic mechanism and physical/sensory manifestation
   b) the controls for the entire universe of content and function
   c) the high level creation, exchange and communication of knowledge
   d) the representation of meaning and the actualization of objectives
   e) the high level database
   f) the navigate, search and browse functions
   g) the data and information
   h) the high level documentation and sourcing and validations
   i) the valuing and value data base and exchange mechanisms
   j) the interaction and activation of social networks of participants
   k) the auto communication to social and professional networks
   l) the production of print and visual media
   m) the production of audio media and sound
   n) a system of education and teaching
   o) collective raw and mediated intellectual property
   p) the cumulative real time or asynchronous synthesis of knowledge
   q) the identification of knowledge needed and the private and mass communication of solicitations for data, input, knowledge creation and any contribution from relevant parties
   r) the identification of a checklist of essential or relevant variables or variable sets.
   s) the perceived relationships among variables and variable sets in systems at any level or perspective view.
   t) a computer aided communicating, networking and sharing system
   u) a manifestation of expression and enjoyment such as knowledge, images, music, art, multimedia
   v) prioritization of what is most important to know, in what way, at both the highest levels and the most detailed levels and perspectives of understanding.
41) Signifying that specific variables are in play, active, significant and relevant can be achieved in one embodiment of the present invention by lighting the semiotic cells representing the variables, by making them more visually prominent, by making them more active, by creating patterns that differentiate them from others and by using keyed colors or size, for example. The instant visual synthesis & patterned meaning of any spatial grouping of variables, cells and variable sets can be controlled by factors such as validity, filters, good-bad scales, activation, intensity, relationship, directionality and cause-effect at any level of detail or model or perspective.
42) The presentation of dynamic semiotic proofs and valuing systems by the present invention can be, in one embodiment, be driven by robust intelligent visual on screen controls accessed via 2D, and simulated 3D and 4D visual screen environments designed to be more like a modern video game—rich in ambiance, context, settings, experiences, multimedia stimulation, navigation, support screens, real time support systems and feedback loops that help the user best achieve their objectives. The environments enable users and creators to capture and produce new constructs and experiences that become part of the continuous stream of participative enhancements.
   1) Controls of the present invention include but are not limited to the robust on screen selection of angles and perspective views, layers, dimensions, model sets, zoom, drill down, multiple windows of comparison and overlay, high level map locations etc.
There are many ways to implement the Proof Process.
In one embodiment, specific patterns constructed of or manifested by visual, auditory and touch media act as semiosis, carrying or conveying meanings that are either previously defined, intuitively understood, or representationally are the same as the meaning.
Patterns that the present invention may embody as mechanisms, compilers, and semiotic signifiers of meaning include but are not limited to:

Visual Patterns
color (hue, value, lightness, chroma, brightness, lighting, saturation, contrast, continuity, opacity, transparency, glow, mix, etc.)
size (nano to macro, relative size, line width, etc.)
shape (geometry, line, spacing, organics/cells, pixels, similarity/difference, nodes, symmetry, sharpness/softness, thickness/thinness, solid/broken, scaffolding, arrays, etc.) Shape can include objects within objects, arrays within arrays, or other multi-tiered systems, as previously described with respect to FIG. 11). Shape can also include relational shape and position.
motion (directionality, form, lines, fill, flow, trajectory, layering, speed, velocity, acceleration, emergence, trails, textures, energy, sequence, consonance/dissonance, interval, randomness, units/strands/threads/fibers/fabrics, cycles, physics properties, source, end, pitch/roll/yaw, dynamics, rotation, transparency/opaqueness, frequency, unfolding/folding, density, gravity/pull/push, cause/effect, interaction, etc.)
change,
ontology/groupings/proximity (zones, sectors, objects within object, etc.)
spatial position/perspective (relative position, 2d, 3d, 4d, view angle, filters, texture form, virtual reality and mixed reality,
continuity, pulsation directionality, connectivity, match/similarity/differentiation, state, place, speed, decay, emergence, time, transformation, form, function, movement, randomness/predictability, repetition, interaction, relationships, zoom, exchange, transference, overlays, layering, 3d, 4d, zones, frequency, arrays, scaffoldings, acceleration, velocity, gravity/pull, orientation, sequence, timeline, slow motion, energy, bonding, angle, dimensionality, text, add (video, text, audio, etc.), line, line flow and line trail, textures, edit & edit trail, creation & creation trail, cadence, canon consonance/dissonance/resonance, energy, dynamic, interval, randomness, units/strands/threads/fibers/fabrics, cycle, source, end, unison, geometry, source engines, trajectory, pitch/roll/yaw, dynamics, rotation, view angle, filters, cycles, parallax, transparency/opaqueness, flow, density, proximity, user initiated interaction, event initiated interaction, polarity, matrix, filaments, scaffolding, cytoskeleton, architectural templates, spatial organization, micro and macro environments, contexts, full range of perspective displays for comparison and systemic comprehension, mechanobiological semiotics, mechanophysical semiotics, resets, struts, membranes, pathways, mediation controls, kernels, nodes, self organizing, autopoietic code, mechanobiological generative code, macrocognitive meaning maps, multivariate mapping, morphing, autocode, consonance with auditory and touch pattern.

Auditory Patterns

Auditory patterns can include pitch, loudness, beat, cadence, harmony, amplitude, timbre, resonance, echo, modulation, progression, overlays, layering, beat, rhythm, scale, tone, frequency, decay, randomness, sonic texture, wave forms, words & word forms, spatial location, build/grow, predictability, music, familiarity, sustain, speed, musicality, parallax, vibration, human resonance, environmental resonance, consonance with visual & touch pattern.

Touch Patterns Touch patterns can include pressure, pulse, frequency, variation, rhythm, harmonics, layers, change, texture, amplitude, predictability, directionality, medium, body location, consonance with visual & auditory pattern, for example.

The dynamic semiotic system of the present invention can, in one embodiment, deconstruct meaning into cognitive and intuitive constructs including but not limited to:

active variables, checklists of variables, proof scaffoldings, validation, verification, documentation, relationships, cause/effect, positive/negative, strong/weak, correlations, layers by nano to macro, layers by degree of scale or detail, layers by high level cells broken into cells within cells, with cells, etc., states/status, projection/extrapolation, history, source, consilience, derivation/synthesis, autopoiesis, dependence vs independence, controllers, switches, activators, sensors, converters, reactors, magnifiers, sequences, time, space, intensity, density, importance, programming, continuity, systemics, catalysts, exchanges, changes, rectifiers, amplifiers, speed, velocity, statistics, physical behavior, physical properties, rules, laws, generators, sustainability, mutation, if/then, scenarios, hierarchies, spectrums, ontologies, autonomic, living, machine, detection, sensors, synthesis, reason, evidence, replication, reproduction, value, range, sensing, stimuli, nurture, equality, components, systems, metrics, measures, relative comparisons, degrees, trajectory, momentum, friction, conscious/subconscious/corporal signals.

The dynamic semiotic system of the present invention can, in one embodiment, organize and optimize for such user objectives as, but not limited to:
Solve a Problem
Identify an Opportunity
Understand/Learn—Past, Present, Future
Impart/Share/Teach
Prevent Something, Cure Something,
Treat Something
Extract Benefit and Value
Share/Exchange/Buy/Sell/Invest/Account/Trade
Relationship
Entertainment/Enjoyment/Plea sure
Health

In one or more embodiments, the following cognitive constructs can be generated:
Proof Process
Meaning
Valuing
Strategy—Planning
Investment ROI/Cost-Benefit
Relationship Protection
Protection/Risk Reduction
Exchange
Valuing
Systemics
Objectives
Cause-Effect
Algorithmic Rules
Weightings
Logic
Reason
Knowledge
Validation
Statistics
History
Project Mgmt
Portfolio Mgmt
Dimensions
Variables
Perspectives
Micro to Macro Scales and Layers
Sequences
Knowledge
Structure
Human Process
Non Human Resources
Strategic Positioning
Pattern (Visual, Kinetic or Auditory)

Valuing

Valuing and Value Exchanges are unique dynamic constructs that fall within and beside the constructs of Proof and Proof Process of the present invention. Value consists of proofs of accurate assessment, validations and verifications of value, trust, assurances of honesty and integrity, feedback loops of measurement and reward, relationships among and between people and among and between people and constructs, tokens of meaning, semiotic markers that carry meaning, certifications, transparency, justice, recognition, market pricing, alternative holistic and systemic costs and pricing, connections and human correlations, human matching, construct matching, sharing markets and exchanges, teaching and learning validations, wealth distributions, systemic wealth redistribution, systemic wealth investment, sustainable systemic mechanisms to achieve specific objectives, nurture, equality, the pursuit of truth, the creation and honoring of principles, the creation and achievement of systemic objectives, the systemic proof process valuing of everything against principles, objectives, priorities or needs.

The present invention of dynamic semiotic proof and valuing systems includes, but is not limited to, a higher order set of semiospheres that enable the proof and valuing systems to more fully, clearly and systemically address context, complexity, manifold perspectives, manifold levels and spectrums of variables, detail and systemic relationships, all of which matter in the pursuit of systemic accuracy and the achievement of a metachecklist of understandings require to satisfy the pursuit of systemic truth.

The present invention of proof and proof process systems is inclusive of valuing and value exchanges, but valuing and value exchanges also have unique features, inventions, and application some of which are described below:

The present invention of a dynamic semiotic valuing system allows for transparent dynamic scaffolds of proof processes and exchange to be applied to the expression, organization and utilization of systemic currencies, exchanges, marketplaces, economies, mass actions, commerce, enterprise, cooperatives, human relationships, human organization, human assessment and feedback loops, human trust and integrity, tokens and markers of direct and indirect, tangible and conceptual, societal and personal, commercial and organizational value.

The present invention, in one embodiment, consists of a semiotic video game like world embedded with specialized dynamic semiotic ontological maps and models that follow sets of variables using omnipresent dynamic interactive model sets through which users across social and commercial communications and computer networks can semiotically follow individuals or organizations digitally, and through the iconic semiotic model sets the user can be directly connected to all forms of value and value representation, interact with the semiotic valuing models through multisensory assessment and recognition, or creation and transfer, of value. The dynamic semiotic valuing models can accumulate, communicate, bank, store, gain interest, invest, expend or trade via semiotic accounting model sets any token of value through the present invention's instant semiotic marketplace. Value can consist of currency, time, promissory notes, futures contracts, investments, sharing, trust, skills, human performance feedback and measurement, relationships, certifications, enterprises, resources, market exchanges, sales, purchases, etc.

In one embodiment, an interactive semiotic system comprehensive valuing may comprise a dynamic valuing marketplace for the exchange of any token of value or any direct or indirect tangible or intangible construct.

The system of the present invention may also comprise, in one embodiment, a structured visual ontological valuing framework that is systemically omnipresent and controlled by voice or touch, or by automated algorithms, whenever an individual, organization, computing or communications device or digital or analog entity interacts with another.

The system of the present invention may also comprise, in one embodiment, a constant computer aided compiler that translates forms of human interaction and status into dynamic semiotic characterizations and representations for the exchange of, and accounting of, value among parties.

The system of the present invention may also comprise, in one embodiment, a semiotic ontological patterned dynamic visual representation of value at all levels of detail across all forms of valuing, utilizing any form of desired objective and subjective value metrics.

The system may also comprise, in one embodiment, a generative engine that transforms any meaningful exchange into a compiler processed visual (and multisenory) registry that tracks, stores, tags, retrieves, replays, verifies, validates, updates and applies rule sets, agreements, manual entries, verified automated cause effect actions across all forms of value, including, but not limited to: currency, trade, time, contract, management, project management, debt, interest, donation, token, future, bond, trigger, tax, punishment, reward, if/then, transfer, approval, rating, trust, skill, match search, metric, grouping, circumstance, markets, commerce, financing, compensation, mass action, distribution, rent, buy, lease, loan, investment, cross exchange, legal construct, shareholder construct, enterprise construct, government construct, cooperative construct etc.

The system may also comprise, in one embodiment, a semiotic network mechanism of instant pattern matching, instant pattern recognition, instant filtering of signal from noise, and instant tracked conversion of inputs to stored knowledge, verification and output such that any user may semiotically recognize a match of another with their objectives.

In one embodiment, the set may be configured such that it functions as a secure cooperative dynamic semiotic electronic banking system capable of verifying and transferring forms of value to all registrants and users, keeping records, sharing forms of value with those within and without the valuing system.

In one embodiment, the system may comprise a systemic compiler/interpreter/translator that contains a checklist and suite of algorithms that deconstruct, convert, and reconstruct any valuing variable into a comprehensive semiotic valuing system.

In one embodiment, the system may comprise code kernels that produce constant motion dynamos and real time generative and dynamic systemic images, animations, avatars, icons, patterns, objects, ontologies, colors, environments, worlds, interactions, changes, and states.

Human exchanges of value take a multitude of forms which the present invention can signify via dynamic systemic semiotics:

Currencies (including an every expanding domain of alternative currencies) and various forms of debt, investment, contracts, evaluations and valuations, documentation & data, notes, recognition and reward, mediated repackagings and administrations, markets, replication and distribution, “likes”, barter, registries of financial instruments and pure giving/sharing represent most if not all of the available mechanisms for valuing among any form of exchange of products, intellectual property, relationships, access/proximity or services.

No fully systemic and semiotic schema exists to define and implement a trustworthy dynamic system that establishes an inclusive semiotic data driven proof process and screen interface for valuing people, objects, intellectual property, and potentials through the exchange of proof process validated information and transparent tokens and tangible forms of reward, recognition, and sharing.

The present invention includes, in one embodiment, a touch enabled color, pattern, cellular ontological omnipresent model set that empowers a subject or a second or third party to instantly characterize and identify their perceived value of an act or a potential, and to authorize the automated or manual transfer and recording and communication of any form of valuing based upon the assessments of the authorized parties.

Above, within and beneath the valuing layer can be a Proof Process depicting all information, evidence, and input associated with the valuing functions.

The criteria for valuing may, in one instantiation, appear as one or more layers of semiotic ontological model sets of cells (cells within cells within cells etc.), avatars, and/or various dimensions of forms that the user selects by click, touch or verbal command.

The selected cells may be visually activated through pattern, light or other visible or auditory features.

All keystrokes, selections, inputs, outputs, sources, proof processes, history, cumulative history, databases model sets, and screens are instantly relationally saved, organized, and stored according to time and space and pattern so they can be browsed, recalled, retrieved, viewed, organized, and displayed in any possible way.

The present invention may be used as a system of banking, investment, compensation, mass action, reward, recognition, sharing, promotion, ownership, cooperative membership and ownership, trade and barter, project management, research and comparison, accumulation, saving and dispensing, legal and contextual, contractual, intellectual property, proof of identity, etc.

Some instantiations of valuing functions can include such variables as: trustworthiness, skill, fortitude, time, kindness, dedication, currency, systemic excellence, integrity, time, resources, futures, loans against future, investment, contracts, financial instruments, proof processes, membership, relationship, intensity, learning capacity, conscious/subconscious & corporal states, proximity, sharing, alternative currencies, objectives matching, value matching, trade, management, project management, debt, interest, donations, tokens, futures, bonds, triggers, taxes, punishments, rewards, if/then, transfer, approval, rating, trust, skill, match search, metrics, grouping, circumstance, markets, commerce, financing, compensation, mass action, distribution, rent, buy, lease, loan, investment, cross exchange, legal constructs, shareholder constructs, enterprise constructs, government constructs, cooperative constructs;

Semiosphere

In order to fully derive, depict or signify proofs, proof processes, value and value exchanges, it is systemically necessary to provide the option for a full contextual environment so that the originator, contributor or user has access to every possible piece of information and perspective necessary to understand the variables and variables relationships external to but associated with understanding and acting upon valuing and proofs. The present invention introduces a Semiosphere, which, in one instantiation, incorporates model sets of proof and valuing into an inclusive family of systemic model sets.

A Universal Dynamic Semiotic System (a Semiosphere) for the Capture and Expression of Systemic Knowledge and Intelligence—9 Models (model 1, Nurture, Equality, Truth and Systems) (model 2, Human Constructs) (model 3, Sway) (model 4, Relationships) (model 5, Y Person) (model 6, Matter:Energy), (model 7, Proof Process and Valuing) (model 8, Media) (model 9, Man-Made)

Model set 1, Nurture, Equality, Truth and Systems (NETS), is a comprehensive representational knowledge model-set that uses unique adaptive systemic ontological and pattern based forms to communicate knowledge according to the mutually inclusive principles, objectives and processes defined by Nurture, Equality, Truth and Systems constructs.

Model set 2, Human Constructs, is a comprehensive representational knowledge model set that uses unique adaptive ontological and pattern based forms to communicate the psycho-social constructions of individual and organizational human based reality, incorporating ideologies, belief systems, cultures and genetic, inherited and experienced (conscious, subconscious, corporal) knowledge frameworks.

Model set 3, Sway, which is a comprehensive representational knowledge model set that uses unique adaptive ontological and pattern based forms to communicate the dynamic forces of human interaction focusing on the conscious, subconscious and corporal possession and transmission of power and influence.

Model set 4, Relationships, is a comprehensive representational knowledge model-set that uses unique adaptive systemic ontological and pattern based forms to communicate the characteristics, dimensions and meaningful networks of human relationships

Model set 5, Y Person, is a comprehensive representational knowledge model-set that uses unique adaptive systemic ontological and pattern based forms to communicate knowledge according to wholly formed representations of one or more human beings, segmented into 3 mutually inclusive ontological sets—conscious, subconscious, corporal.

Model set 6, Matter:Energy, is a comprehensive representational knowledge model-set that uses unique adaptive systemic ontological and pattern based forms to communicate the entire spectrum of matter and energy, from nano to macro.

Model set 7, Proof Process and Valuing, is a comprehensive representational knowledge model-set that uses unique adaptive systemic ontological and pattern based forms to communicate knowledge in the form of proofs, proof processes, valuing and value exchanges

Model set 8, Rich Media, is a comprehensive representational knowledge model-set that uses unique adaptive systemic ontological and pattern based forms to communicate knowledge according to all forms of media and sensory expression, including movies, documents, photographs, documentation, research reports, graphics, statistics, visualizations, sounds, music, gaming, recordings, artifacts, art, images, tactile and kinetics, instruments, books, electronic media, stored media etc.

Model set 9, Man-Made, is a comprehensive representational knowledge model-set that uses unique adaptive systemic ontological and pattern based forms to communicate knowledge according to what human being create by changing, harvesting, manufacturing, shaping, building and utilizing all forms of matter and energy.

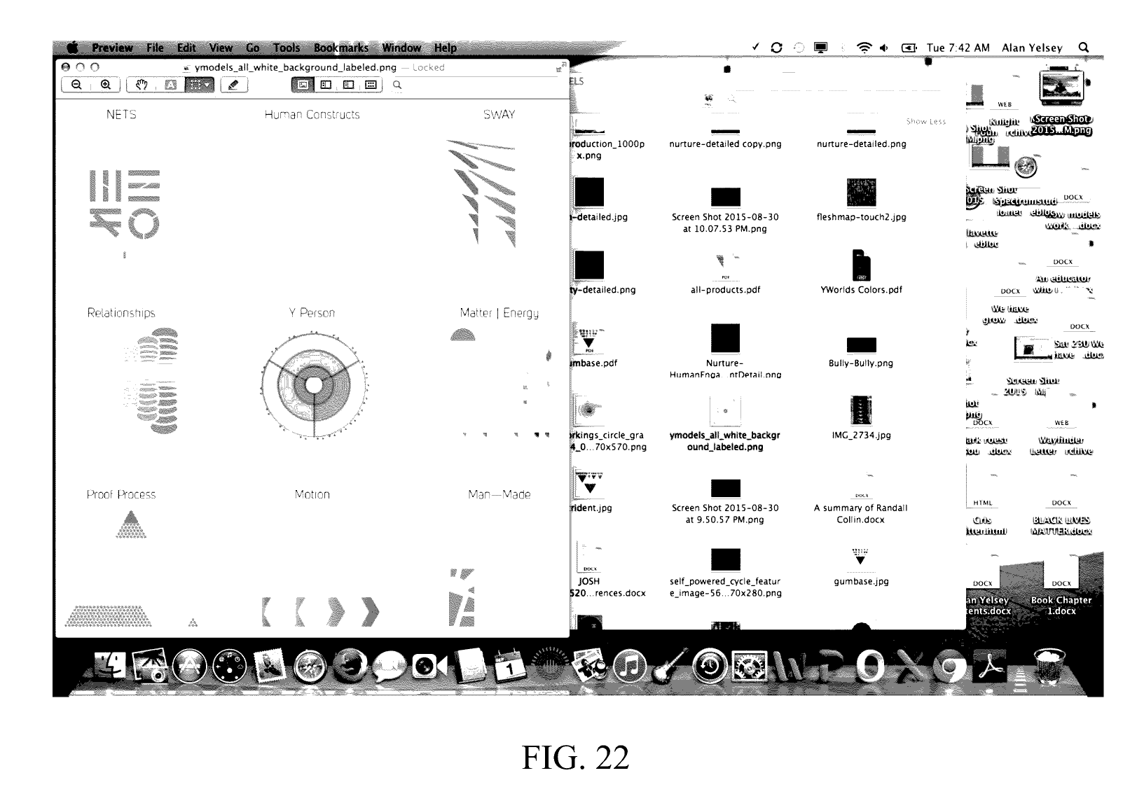

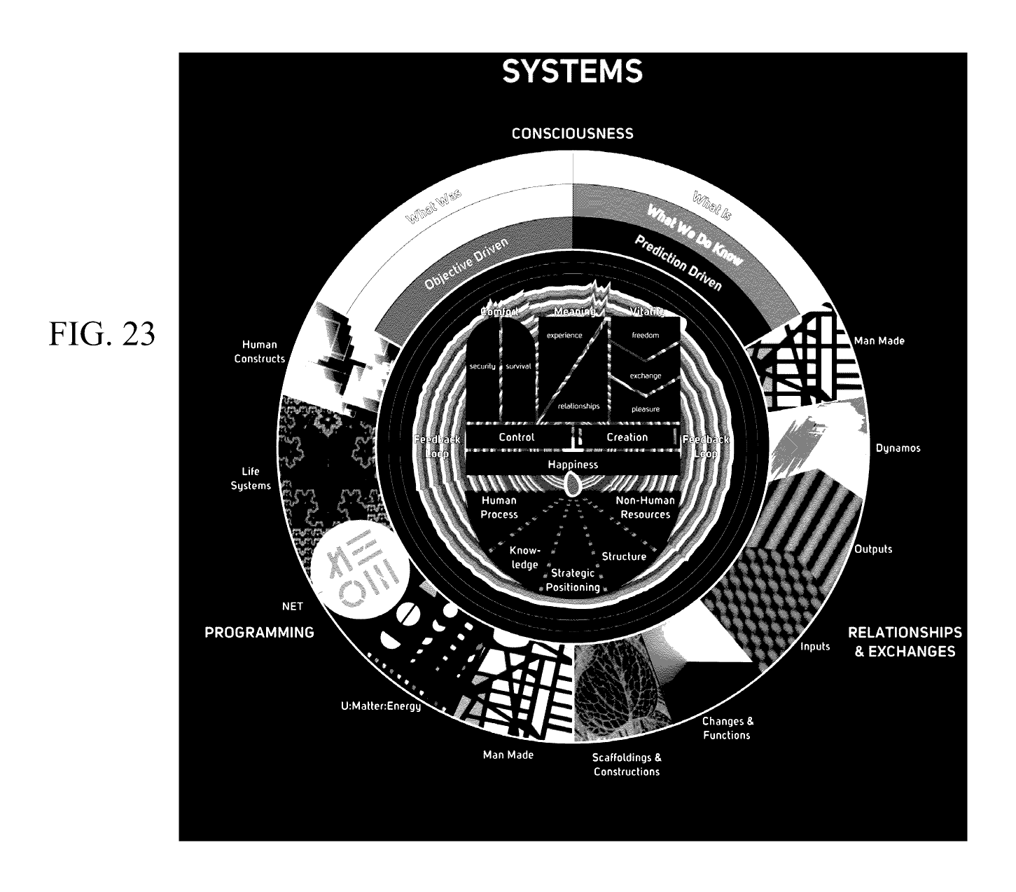

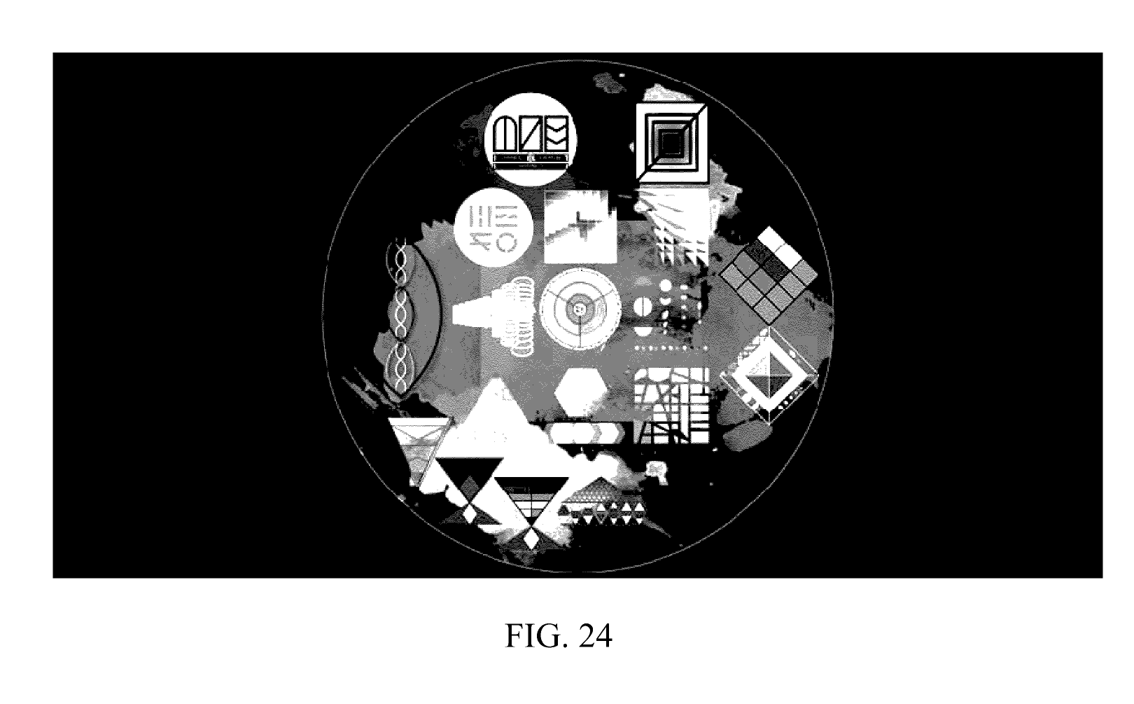

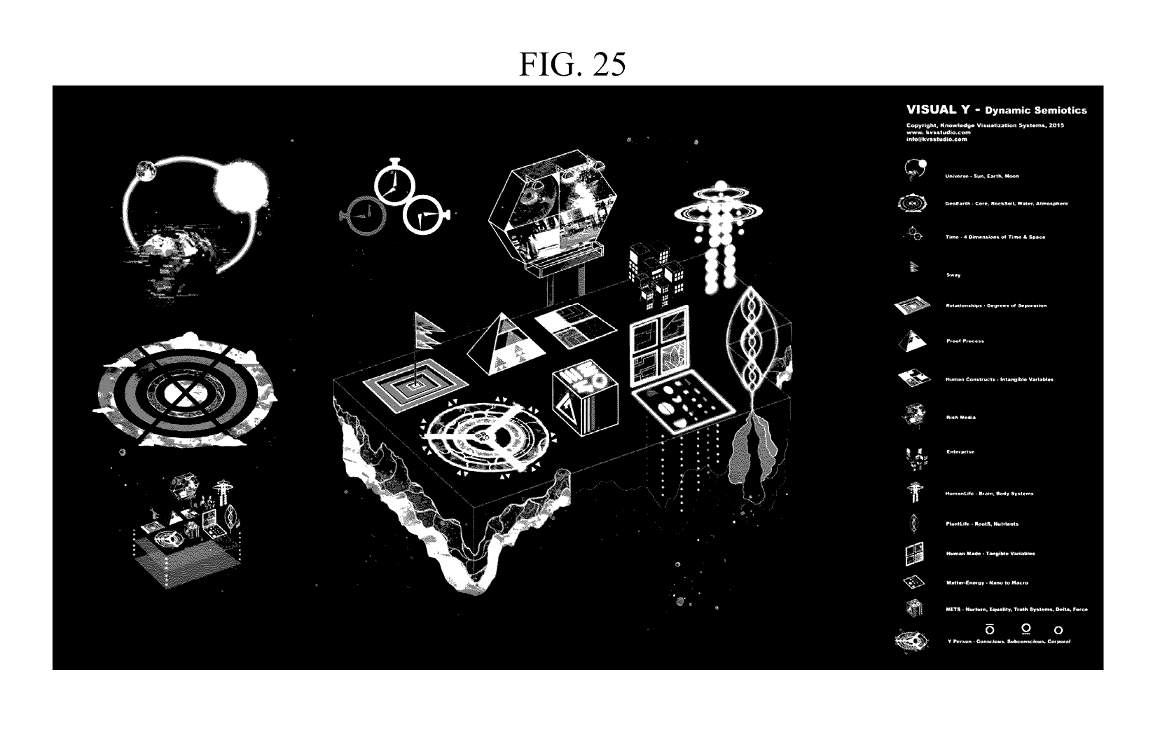

Embodiments of semiospheres within the present invention include an environment of semiotic model sets. FIG. 22 is a high level screenshot of the 9 model sets described above. FIGS. 23 and 24 represent embodiments of semiospheres that include the FIG. 22 model set. FIG. 25 is an embodiment of a universal high level semiosphere that contains the FIG. 22 model set and a range of additional model sets comprising, in this instantiation, an example of a universal proof and valuing portal set within a universal semiosphere of systemic knowledge. FIG. 25 expresses knowledge as a mutually inclusive dynamic, cybersemiotic, systemic, interactive multisensory embodiment of the following model sets:

Modelsets 1-9 from above plus:
The physical Universe
GeoEarth—The physical earth
Time & Space
Enterprise
Human Life
Plant Life
Layers of Detail, Granularity, Perspective, Dimensionality

In one embodiment, the semiospheric set may be controlled by a video game like interface, navigation, search, and display within and among a video game like virtual reality environment.

In one embodiment, the semiospheric set may be presented within said ontological patterned frameworks as part of a representation of comprehensive knowledge created by the software engines based upon generative computer codes applied by one or more processors or servers.

In one embodiment, the semiospheric set may be presented within said ontological patterned frameworks as part of an internet browser based representation of comprehensive knowledge.

In one embodiment, the semiospheric set may be statically presented and outputted within the ontological patterned frameworks or presented and outputted in motion so as to be changing across time and space.

In one embodiment, the semiospheric set may be configured to comprise ontological patterns of sound, song, and audio effect as stand-alone sequences or in partnership with video sequences and static states in order to convey meanings.

In one embodiment, the semiospheric set may be represented by patterns and forms optimized by user selected objectives and the system's evaluation of the user's maximized or preferred methods of learning and discerning patterns and forms in order to process intended meanings.

In one embodiment, the semiospheric set may be interactive, dynamic and robust to the extent that any user can contribute to the ontologies, patterns, detail and documentation at any level and dimension, using an inclusive hive mechanism that prolifically solicits and rewards inputs and contributions and mediations and verifications of knowledge in order to form the sets and the content beneath.

In one embodiment, the semiospheric set may be configured such that its higher levels contain extensive multimedia representations of the most current variables, groupings, systemic relationships and meanings and whose lower levels contain more traditional sets of text, graphics, images, sources, documentation, alternative perspectives and archival content, all visually tagged and linked to each other through ontology, pattern and perspective.

In one embodiment, the semiospheric set may be composed of robust and changing arrays of models, scaffoldings and environments that consist of ontological building blocks that each represents a grouping of constructs and variables. A single pixel or sound can represent a single variable. Each ontological component or cell is divided into lower layers of components or cells and so on until the entire depth and breadth of an objective is available on screen, along with all peripheral sets and controls and perspective views.

In one embodiment, the semiospheric set may be configured such that it stores, organizes, and expresses meaning at the highest levels through the user's experience of, and modification of, the environments composed of semiotic visual and auditory stimuli which synchronize and semiotically compile a systemic language.

In one embodiment, the dynamic semiospheric set may be programmed to be generative and autopoietic, meaning it possesses characteristics of living organisms, of the dynamos driving energy and matter, and of the behaviors of biological-mechanical and physics-mechanical interactions.

In one embodiment, the semiospheric set may be composed of a software toolset that enables and empowers users to create, craft or modify the forms, media, linkages, environments, patterns and behaviors of new or existing sets with simple touches of screens, cells, controls, and objects with every input captured as recallable historic record in a form consistent with and optimized for real time generative relational code.

In one embodiment, the semiospheric set may be configured such that any component or model within said set is robust, scalable, malleable and mobile, with the user able to navigate, select, browse, zoom, dynamically view timelines, select, size and place models at any desired level or levels and run dynamic sequences.

In one embodiment, the semiospheric set may be comprised of predefined multimedia pattern schemes comprising a plurality of multimedia elements each having a different assigned meaning within a structured visual environment consisting of ontologies, patterns, forms and worlds within which sets of the plurality of multimedia elements are presented.

In one embodiment, the semiospheric set may be user configured or automatically configured for viewing according to the objectives of the user through positioning controls that orient the semiotic models, forms, content and the entire environment for best systemic and meaningful comprehension.

In one embodiment, the semiospheric set may be portrayed in static print form, static computer device display form, 2 dynamic visual dimensions, 3 dynamic visual dimensions, 4 dynamic visual dimensions, by hand signal, by touch and motion, by hand sketch and by abbreviated text or verbal/sound/music.

In one embodiment, the semiospheric set may manually or automatically connect via communications and computer devices and social and commercial networks to individuals, media and organizations in order to poll, query, solicit and revisit specific or general cohorts, experts, experiential contributors, databases, archives, sources of knowledge, researchers and observers, demographic groupings and users for the purpose of populating, verifying, modifying and creating knowledge sets, with each input channeled automatically and semiotically into all applicable proof variables for immediate or moderated access.

In one embodiment, the semiospheric set may be configured such that it functions as a secure cooperative knowledge portal capable of attracting, soliciting, receiving, organizing, storing, verifying and applying all forms of knowledge input and then making all such knowledge available to all users.

The Semiospheric set, in one embodiment, embeds meaning through systemic, ontological forms that are populated by orchestrated patterns and flows of color and sound. These dynamic, generative visualizations and auditory propagations will comprehensively translate and compile complexity into understanding. Patterns of meaning are embedded in these maps and models and these patterns emerge according to the objectives of the end user.

The semiospheric set, in one embodiment, is composed of families of interlinked mutually inclusive models, each representing a unique perspective while sharing at every level and dimension the knowledge, properties, linkages and changes expressed within and among other models. Adding one element to one model generates a relational and systemic cascade of changes to all other models sharing common variables and elements or sharing cause and effect relationships. From nano to macro, each and every model expresses a unique yet mutually inclusive view of systemic knowledge that together produce a comprehensive systemic understanding of the dynamic semiotic proofs and valuing of the present invention.

In one embodiment, a dynamic, interactive, cybersemiotic system is one that links with, recompiles and transforms words, numbers, graphics and their associated computer codes into higher order semiotic forms, meanings. interfaces, databases, codes and communications that consist of interactive dynamic systemic semiotic methods, modelsets and interactive dynamic systemic semiotic model-based interactive worlds composed of standardized ontological groupings of variables and subvariables signified as families of unique shapes and cells with subvariables represented by layers of unique macro to micro subcells and subshapes, all filled with dynamic standardized languages of robust and adaptable color, pattern, action and interaction that convey cognitive systemic semiotic meanings that can signify complex processes, understandings, multivariate understandings, dimensionalities, changes, predictions and perspectives according to the objectives of the originator, user, moderator or agent using a dynamic range of sensory multimedia including visual, auditory and kinetic.

Such systems can include a transformer or multi-directional compiler, an engine and toolset to enable semiotic input and output, and accumulator of knowledge, a standardized yet robust and adaptive method of using shapes, colors, patterns, forms, models, ontologies, visuals, motion, sound and kinetics to create rich systemic semiotic communications that conveys complex multivariate meaning, displays relationships among variables across time, space and context, organizes information so that it can be optimized through semiotics for cognition and enjoyment, for example. Multiple, mutually inclusive dynamic inter-linked semiotic modelsets, semiospheres, depicting all associated variables can be selected according to desired perspectives and objectives. Embodiments can transform words, numbers, charts and linearity into cybersemiotic meaning and such transformations can be output through a computer interface, virtual reality and mixed reality system and 3D sensory system. In embodiments, the system can be a connector of dots and recognize elements of proofs or syllogisms.

In another embodiment, an interactive semiotic communication system comprises a software engine, toolset, language and control-set that enables originators, users, contributors, moderators, and third party agents to produce and interact with schemes and protocols of ontological frameworks, patterns, animations, motion, objects and colors within a complete multi-dimensional environment. The software engine, toolset, language and control-set records, tags, stores, archives histories and documentation, propagates associated links and changes, codes, updates, retrieves and re-creates changes to the semiotic models and environments, in embodiments. In the interactive semiotic communication system, every component and model within said set is robust, scalable, malleable and mobile, with the user able to simply navigate, select, size, place output, input, browse, zoom, dynamically view all content at any desired level or levels, within and among any model sets, and run dynamic sequences. The set can be user configured or automatically configured for viewing according to the objectives of the user through positioning controls that orient the semiotic models, forms, content and the entire environment for best systemic and meaningful comprehension.

According to another embodiment, a specialized relational data base produced by the process of identifying a set of variables, constructing a data set through a dynamic interactive semiotic pattern interface that identifies data corresponding to the variables, and relationships between the variables in such a way that knowledge corresponding to the set of variables can be organized at multiple levels wherein the data set can be modified, stored, searched, browsed and retrieved via a visual interface composed of representational visual content and powerful intuitive soft and hard controls, a generative visual registry that tracks, stores, tags, retrieves, replays, updates and applies rule sets, agreements, manual entries, verified automated cause effect actions relating to the variables, a systemic semiotic compiler configured to produce constant motion dynamos and real time generative images, animations, patterns, objects, ontologies, colors, environments, worlds, interactions, changes and states.

According to another embodiment, an interactive semiotic communication system for comprehensive valuing, the communication system includes a dynamic valuing system for the exchange of any token of value or any direct or indirect tangible or intangible valuing construct, a structured visual ontological valuing and value exchange framework that is systemically omnipresent and controlled by voice, text or touch, or by automated algorithms, whenever an individual, organization, computing or communications device or digital or analog entity interacts with another, a computer aided cybersemiotic mechanism that characterizes and represents the exchange of value among parties and between parties and computing devices, a relational data base and a relational semiotic database constructed through a dynamic interactive semiotic pattern interface and semiotic compiler that automatically codes, tags and characterizes all relevant or essential variables and all relationships and states among the variables, including a family of perspectives, dimensions and characterizations, in such a way that all knowledge at the highest levels can be organized, modified, stored, searched, browsed and retrieved via a multisensory interface experienced through representational visual content and powerful intuitive soft and hard controls, a generative engine and semiotic compiler that transforms any meaningful exchange of proof or value into a visual, sensory and relational data base registry that tracks, stores, tags, retrieves, replays, updates, transfers, transmits and applies rule sets, agreements, manual entries, verified automated cause effect actions across all forms of proof and value.

A biosemiotic compiler that utilizes such brain constructs as cells, neurons, synapses, dendritic spines to create geographically defined connective networks of associative and relational meaning and memory in order to semi-autonomically create forms and patterns that optimize how cognitive semiotics represents proofs, proof processes, value, value exchanges and systemic knowledge in general.

According to another embodiment, an omnipresent multisensory connective semiotic compiler identifies, links, translates or transforms each individual variable of a systemic into a dynamic relational cybersemiotic systemic mapset of form and pattern wherein originators, mediators or users can identify semiotically via touch, text, keyboard, mouse, motion, or voice how each variable corresponds, relates and exchanges with every other variable to produce value, value exchanges, proofs and proof processes and semiospheric environments and whereby the connective compiler produces target code, object code, generative codesets, verification and documentation, and ontologically organized accumulation across all variables and agents associated with a chosen subject, an objective, an input, a perspective, a context, a systemic, or a dimension or layer including nano to macro.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. §112(f) are not to be invoked unless the specific terms “means for” or “step for” are recited in a claim.

What is claimed is:

1. A robust, scalable, interactive dynamic cybersemiotic system comprising:
means for adding, accumulating and summarizing data into a dynamic systemic semiotic database;
means for capturing, creating, transforming, organizing, storing, and retrieving the data and providing accumulative interrelationships and systemic meaning therebetween;
means for outputting the data through a standardized dynamic semiotic arrangement, providing representation and communication of multisensory systemic meaning in the form of semiotic proofs, exchanges of value, modelsets, semiospheres, objectives, perspectives, comprehensive knowledge and systemic context.

2. The system of claim 1, wherein the means for adding, accumulating, and summarizing data into a dynamic systemic semiotic database is multisensory.

3. The system of claim 1, wherein the means for capturing, creating, transforming, organizing, storing, and retrieving the data and providing relationships and systemic meaning therebetween comprises a multi-directional compiler.

4. The system of claim 3, wherein the multi-directional compiler is adapted to both:
arrange the data into the dynamic semiotic database; and
generate the standardized dynamic semiotic arrangement as the means for outputting, according to a desired multisensory form.

5. The system of claim 3, wherein the compiler provides interrelationships that can be depicted as a plurality of variables, each variable comprising a sub-ontology.

6. The system of claim 1, wherein the standardized dynamic semiotic arrangement comprises one or more elements selected from the group consisting of:
color, form and pattern, space and time representations;
acoustic representations; and
kinetic or taptic representations.

7. The system of claim 1, wherein the means for outputting further comprises an omnipresent toolset.

8. The system of claim 1, wherein the standardized dynamic semiotic arrangement includes accumulative linked references to an underlying documentation provided to the multisensory means for adding.

9. A semiotic system that facilitates information storage, accessibility, and communication via a computerized, dynamic interactive semiotic system, the semiotic system comprising:
a data collection interface configured to receive information in real time from a user via an input interface;
a software engine that encodes the received information from the input interface to a multidimensional cybersemiotic environment;
a cybersemiotic multi-directional compiler configured to:
translate data, information, knowledge, graphics and content into a multisensory (visual, virtual reality, mixed reality, auditory, touch/kinetic) family of dynamic semiotic ontological frameworks, semiotic representations and relational data in an array;
transform source code into object code/machine language in a second array; and
translate multisensory inputs into source code in a third array;
an output interface receive information from the cybersemiotic multi-directional compiler, the output interface having an omnipresent toolset, the output interface having a plurality of linked scaffolds, pixels, cells, forms, shapes, progressions, arrays and continuums signifying the received information, patterns, relationships and logic structures associated with a topic.

10. The semiotic system of claim 9, wherein the input interface is multisensory.

11. The semiotic system of claim 9, wherein the multi-directional compiler is adapted for capturing, creating, transforming, organizing, storing, and retrieving the information from the data collection interface and providing accumulative relationships and systemic meaning therebetween.

12. The semiotic system of claim 11, wherein the multi-directional compiler is adapted to arrange the data into a dynamic semiotic database according to the family of semiotic ontological frameworks corresponding with the topic.

13. The semiotic system of claim 11, wherein the multi-directional compiler is adapted to output the received information according to cybersemiotic scheme.

14. The semiotic system of claim 13, wherein the cybersemiotic scheme is multisensory.

15. The semiotic system of claim 9, wherein the received information can be depicted as a plurality of variables, each variable comprising a sub-ontology.

16. The semiotic system of claim 9, wherein the standardized dynamic semiotic arrangement comprises one or more elements selected from the group consisting of:
color, form, and pattern, space and time representations;
acoustic representations; and
kinetic or taptic representations.

17. The semiotic system of claim 9, wherein the dynamic semiotic arrangement includes linked references to an underlying documentation.

18. A robust scalable interactive dynamic cybersemiotic system comprising:
semiotic compilers, software engines, controls, processes, mechanisms and physical and sensory manifestations for the input, accumulation, derivation, production, storage, display, broadcast, output, modification, manipulation, search and communication of proofs and proof processes, valuing and value exchanges and the semiospheric accumulation, organization and communication of a universe of multivariate information and systemic relationships;
a software engine that encodes and powers a manual, semi-autonomous and autonomous construction of a dynamic, interactive, scalable, robust, accumulative multisensory, multidimensional cybersemiotic environment capable of representing meaning in the form of semiotic proofs, valuing, exchanges of value, data, knowledge and systemic context;
a multisensory semiotic control system that enables originators and users to navigate in and through a multi-dimensional semiospheric world composed of objects, patterns and model sets, to create, manipulate and modify objects, to map context and orientation, to generate visual, auditory and touch patterns, shapes, forms and motions, and to save, store, document and retrieve any creations and to accumulate and mediate content and deploy toolsets and applications;
an omnipresent toolset comprising a multi-directional cybersemiotic compiler that translates data, information, knowledge, graphics and content into an accumulative multisensory (visual, auditory, touch/kinetic, virtual and mixed reality) family of dynamic semiotic ontological frameworks, semiotic representations and relational data in one array, transforms source code into object code/machine language in a second array and translates multisensory inputs into source code in a third array;
a format of sensory linked scaffolds, pixels, cells, forms, shapes, progressions, arrays and continuums signifying the variable sets, patterns, relationships and logic structures associated with the accumulation, documentation, validation and construction of proofs and valuing corresponding to a question, a systemic understanding, a subject or an objective; and
an interactive semiotic communication system wherein said set can manually or automatically connect via communications and computer devices and social and commercial networks to individuals, media and organizations in order to poll, query, solicit and revisit specific or general cohorts, experts, experiential contributors, databases, archives, sources of knowledge, researchers and observers, demographic groupings and users for the purpose of accumulatively populating, verifying, modifying and creating proof and valuing sets, with each input channeled automatically into all applicable variables and model sets for immediate or moderated access, wherein the accumulative cognitively optimized system is implemented on and through an interactive computing device or devices with a processor and communications interface.

19. The dynamic cybersemiotic system of claim 18, wherein the semiotic representations comprise at least one of a selection of semiotic patterns, a selection of semiotic animations, a selection of semiotic sounds, a selection of semiotic virtual and mixed realities, a selection of semiotic touch/kinetics, a selection of time and space context, a selection of semiotic objects or a selection of semiotic colors and groupings wherein the user interface is configured to allow the user to select and interact with one or more options from the toolset.

20. The dynamic cybersemiotic system of claim 19, wherein the software engine is configured to record and store the selection and corresponding changes to the semiotic environment such that the selection and corresponding changes are available for later retrieval.

21. The dynamic cybersemiotic system of claim 18, wherein said set is interactive, dynamic, accumulative and robust to the extent that any user can contribute to the ontologies, patterns, detail and documentation at any of a plurality of levels, using an inclusive hive mechanism that prolifically solicits and rewards inputs and contributions and mediations and verifications of knowledge in order to create the sets of form and pattern and the content beneath.

22. The dynamic cybersemiotic communication system of claim 21, wherein a highest one of said set's plurality of levels contains extensive multimedia representations of the most current variables, groupings, systemic relationships and meanings and whose lower levels contain more traditional sets of text, graphics, images, sources, documentation, alternative perspectives and archival content, all visually tagged and linked to each other through ontology, pattern and perspective.

23. The dynamic cybersemiotic system of claim 18, wherein said set is comprised of predefined or user defined multimedia pattern schemes comprising a plurality of multimedia elements each having a different assigned meaning within a structured accumulative visual environment consisting of ontologies, patterns, forms and worlds within which sets of the plurality of multimedia elements are presented.
